(19) United States
(12) Patent Application Publication
(10) Pub. No.: US 2010/0020966 A1
(43) Pub. Date: Jan. 28, 2010

(54) METHOD FOR GENERATING ENCRYPTION KEY

(75) Inventors: Yoichi Hata, Kanagawa (JP); Toshiaki Kakii, Kanagawa (JP); Yasuhito Fujita, Kanagawa (JP); Yoshimitsu Goto, Kanagawa (JP); Hitoshi Kiya, Tokyo (JP); Kiyoshi Nishikawa, Tokyo (JP); Masaaki Fujiyoshi, Tokyo (JP); Shoko Imaizumi, Tokyo (JP)

Correspondence Address: MCDERMOTT WILL & EMERY LLP, 600 13TH STREET, N.W., WASHINGTON, DC, 20005-3096, US

(73) Assignees: SUMITOMO ELECTRIC INDUSTRIES, LTD., Osaka (JP); TOKYO METROPOLITAN UNIVERSITY, Tokyo (JP)

(21) Appl. No.: 12/522,642

(22) PCT Filed: Nov. 4, 2008
(86) PCT No.: PCT/JP2008/070037

§ 371 Date: Jul. 9, 2009

(30) Foreign Application Priority Data
Nov. 5, 2007 (JP) 2007-287756
Apr. 17, 2008 (JP) 2008-108115

(51) Int. Cl. H04L 9/00; H04L 9/14

(52) U.S. Cl. 380/44

(57) ABSTRACT

The present invention relates to an encryption key generating method ensuring resistance to collusion attacks and achieving reduction in a key length of encryption keys corresponding to respective hierarchies of each scalability. In the encryption key generating method, an encryption key (K_{2,2}) corresponding to data in the lowest hierarchies of hierarchical scalabilities (R, L) is divided as a master key by the number of hierarchies in scalability (R). Key element matrices (M1-M3) generated with respective split keys (e_{R2}, e_{R1}, e_{R3}) are assigned operation data successively obtained by repeating a hash operation with a one-way hash function, so as to maintain hierarchical nature of scalability (L). Partial keys (K_{1,1}-K_{2,2}) corresponding to respective hierarchies of the scalabilities (R, L) are generated by combining key elements coordinately consistent among the key element matrices (M1-M3).

### TECHNICAL FIELD

The present invention relates to generation of an encryption key used in coding (encryption) and decoding (decryption) of digital data with plural types of hierarchical scalabilities and, more particularly, to a technology of automatically generating partial encryption keys corresponding to respective data units in hierarchies in each scalability.

### BACKGROUND ART

In recent years, the spread of information and communications services through networks has also increased services to transmit data to unspecified masses, e.g., a delivery service of digital contents such as images (including one-frame data of a moving picture). In conjunction therewith, there is a demand for highly advanced functionality in protection technology of digital data.

In general, a coded digital image or the like is decoded in a quality (distortion, resolution, color representation, or the like) determined in a coding process. With diversification of communication channels, diversification of communication terminals, and diversification of delivery services, there is a demand for capability of decoding the image in a quality different from the quality determined in the coding process, by decoding a certain part of a codestream, i.e., scalability. For meeting this demand for scalability, for example, JPEG2000 (Joint Photographic Experts Group 2000) being the international standard of image compression provides hierarchized scalabilities with scales such as resolution. In the protection technology of hierarchically protecting data in different qualities, it is common practice to perform encryption using individual partial keys for respective data units located in respective hierarchies in each of scalabilities.

The known protection technologies of digital data as described above include, for example, those of Patent Documents 1 and 2 and Non-patent Documents 1 to 3.

Non-patent Document 1 discloses the technology of generating partial keys corresponding to data units in lower hierarchies from one master key by applying a one-way hash function to digital data with hierarchical scalabilities. Non-patent Document 2 discloses the technology independent of an order of streaming data, which is a problem of Non-patent Document 1. Furthermore, Non-patent Document 3 cited above discloses the technology of improving the resistance to collusion attacks, which is a problem of Non-patent Document 1.

A collusion attack is such an act that plural types of encryption keys corresponding to different hierarchical levels in respective scalabilities are shared among a plurality of users, so as to implement reproduction of the image in a quality higher than a preliminarily authorized quality.
Patent Document 1: Japanese Patent Application Laid-open No. 2004-312740
Patent Document 2: Japanese Patent Application Laid-open No. 2003-204321
Non-patent Document 1: Y Wu, D. Ma, and R. H. Deng, “Progressive protection of JPEG 2000 condestreams.” In Proc. IEEE ICIP, pp. 3447-3450, 2004
Non-patent Document 2: M. Fuhiyoshi, S, Imaizumi, and H. Kiya, “Encryption of composite multimedia contents for access control,” IEICE Trans. Fundamentals, Vol. E90-A, No. 3, pp. 590-596, March 2007
Non-patent Document 3: Shoko Imaizumi, Masaaki Fujiyoshi, Yoshito Abe, and Hitoshi Kiya, “Hierarchical encryption method of JPEG2000 for coded images with resistance to collusion attacks,” IEICE SIP symposium, 2006

### DISCLOSURE OF THE INVENTION

### Problem to be Solved by the Invention

The inventors thoroughly investigated the conventional data protection technologies and found the following problem. Namely, for hierarchically protecting digital data of different qualities, encryption keys are separately managed for respective types of scalabilities, or the encryption is carried out using individual encryption keys (partial keys) for respective data units located in respective hierarchies in each of scalabilities.

Particularly, in the case of managing individual partial keys generated for respective data units, an increase in the number of hierarchies leads to an increase in the number of keys to be managed, and a sufficient key length has to be ensured in order to maintain the resistance to collusion; therefore, the total key length will be considerably long with increase in hierarchies in each scalability.

On the contrary, in the case where partial keys corresponding to respective data units are generated from one master key, it is necessary to divide the master key by the number of partial keys, and, as in Non-patent Document 3, an increase in the number of partial keys will inevitably result in shortening the length of each partial key to be generated. In this case, the sufficient resistance to collusion cannot be ensured.

The present invention has been accomplished in order to solve the problem as discussed above, and an object of the present invention is to provide an encryption key generating method ensuring sufficient resistance to collusion attacks on digital data with hierarchical scalabilities and achieving drastic reduction in the key length of encryption keys corresponding to respective hierarchies in each scalability.

### Means for Solving the Problem

An encryption key generating method according to the present invention is to generate an encryption key used in coding and decoding of digital data with plural types (≧2) of hierarchical scalabilities. The encryption key generating method is applicable to picture transmission systems and teleconference systems using multimedia such as packet codestreams of JPEG2000 being the international standard of image compression and also applicable to streaming delivery services. The encryption key generating method is configured to generate partial keys of hierarchies at subordinately higher positions from a master key and to enable simultaneous access control on a plurality of scalabilities by a single codestream.

Specifically, an encryption key generating method according to the present invention comprises generating partial keys corresponding to data units in hierarchies in each of two types of scalabilities selected, as a minimum processing unit. The encryption key generating method comprises setting a master key, generating split keys from the master key, generating key element matrices corresponding to the respective split keys, and generating partial keys by combining entries of the generated key element matrices. The key element matrices are generated based on the split keys corresponding to the respective hierarchies, on a hierarchy-by-hierarchy basis of one scalability. In each key element matrix, coordinates of each entry are defined by respective hierarchical values (corresponding to hierarchical levels) in the two types of scalabilities, whereby each matrix entry coordinately corresponds to a data unit in respective hierarchies in the two types of scalabilities. The encryption key generating method is characterized by generating each of the partial keys in hierarchies at subordinately higher positions from the only managed master key. Therefore, partial keys in hierarchies at subordinately higher positions are also generated from a master key on a decryption occasion and, for example, in a multimedia delivery service, a user receives only a delivered decryption key for the lowest packet in a packet group authorized to open. In this case, the given decryption key itself serves as the master key in the encryption key generating method and each of hierarchies in respective scalabilities corresponding to this master key is the lowest hierarchy.

First, set as the master key prepared is an encryption key used in coding and decoding of a data unit in hierarchies at the lowest position in each of first and second scalabilities selected from the plural types of scalabilities which the digital data as a coded object has. On the contrary, when the master key is a decryption key obtained by delivery or the like, each of hierarchies in respective scalabilities corresponding to the master key is the lowest hierarchy. This master key is divided by the number of hierarchies in the first scalability set as a reference scalability out of the first and second scalabilities, to generate split keys corresponding to the respective hierarchies of the first scalability.

Key element matrices generated based on the respective split keys coordinately correspond to data units in respective hierarchies in the first and second scalabilities. In generation of a key element matrix generated based on one split key out of the resultant split keys, at least coordinate entries corresponding to respective hierarchies from the lowest hierarchy to the highest hierarchy in the second scalability in the hierarchy in the first scalability corresponding to the one split key are assigned operation data successively obtained by repeating a hash operation on the one split key using a one-way hash function. This maintains the hierarchical nature of the second scalability.

The subsequent step is to combine key elements coordinately consistent among the key element matrices generated with the respective split keys, thereby generating partial keys corresponding to data units in the respective hierarchies in the first and second scalabilities. This configuration also maintains the hierarchical nature of the first scalability.

In the encryption key generating method according to the present invention, the aforementioned reference scalability to be selected is preferably a scalability having a smaller number of hierarchies out of the first and second scalabilities. This configuration is less likely to be affected by increase in the number of hierarchies in one or more scalabilities.

In a key element matrix generated based on one split key out of the split keys, coordinate entries corresponding to respective hierarchies from the lowest hierarchy to the highest hierarchy of the second scalability in a hierarchy at a lower position than the hierarchy in the first scalability corresponding to the one split key are assigned the same operation data as the operation data successively obtained for the hierarchy of the one split key. On the other hand, all coordinate entries corresponding to respective hierarchies from the lowest hierarchy to the highest hierarchy of the second scalability in a hierarchy at a higher position than the hierarchy in the first scalability corresponding to the one split key are assigned operation data obtained by a hash operation with a one-way hash function on a key element in the highest hierarchy of the second scalability out of key elements in the hierarchy corresponding to the one split key.

As described above, the encryption key generating method according to the present invention is not restricted by progression orders of codestreams, different from the conventional encryption key generating methods required to prepare a plurality of codestreams and master keys according to progression orders. Furthermore, the encryption key generating method according to the present invention generates the encryption keys (partial keys) corresponding to respective data units subordinately from the master key and enables simultaneous access control on a plurality of scalabilities by a single codestream. This achieves drastic reduction in information amount of the codestream and managed encryption key (master key) and enables effective improvement in safety in management and delivery of digital contents and the encryption key.

Furthermore, when the encryption key generating method according to the present invention is applied to a case where digital data as a coded object has three or more types of scalabilities, two types of scalabilities are selected out of these three or more types of scalabilities, and partial keys are generated by executing the aforementioned minimum processing unit, for all combinations of two types of scalabilities selected out thereof.

Namely, with all the combinations of two types of scalabilities, a partial key element matrix is generated for each combination. On this occasion, a hierarchy table is also generated as one showing all combinations of hierarchical values in the plural types of scalabilities. This hierarchy table is a coordinate representation of partial key matrices whose entries are partial keys corresponding to data units of respective hierarchical values in the plural types of scalabilities, by combinations of hierarchical values. This hierarchy table shows a correspondence relation between the types of scalabilities and the hierarchical values and entries of the partial key element matrices generated for all combinations of scalabilities can be specified from this relation.

Then this invention involves combining entries in the respective partial key element matrices generated for all the combinations of two types of scalabilities, each of which is specified by two hierarchical values out of hierarchical values constituting one combination and types of scalabilities thereof, for all the combinations of hierarchical values in the hierarchy table. An element resulting from this combining step for each combination of hierarchical values is an entry in a partial key element matrix as it is. Therefore, partial keys corresponding to data units in respective hierarchies in the plural types of scalabilities are sequentially generated by combining entries made in correspondence by the hierarchy table from the respective partial key element matrices.

In the generation of the encryption key used in coding and decoding of digital data with hierarchical scalabilities being three or more types of scalabilities, the resistance to collusion attacks can be further improved in comparison with the above-described encryption key generating method.

Specifically, prepared as a master key is an encryption key used in coding and decoding of a data unit in hierarchies at the lowest position in each of three or more types of scalabilities (in the case where the master key is a decryption key obtained by delivery or the like, each of hierarchies in the respective scalabilities corresponding to the master key is the lowest hierarchy). At this time, first and second reference scalabilities are also selected from the three or more types of scalabilities. The first reference scalability is a scalability for generation of split keys from the prepared master key and the prepared master key is divided by the number of hierarchies in the first reference scalability, thereby generating split keys corresponding to the respective hierarchies in the first reference scalability. On the other hand, the second reference scalability is a scalability for defining an operation direction of the hash operation with the one-way hash function as described above.

In the encryption key generating method, a multidimensional key element matrix as a coordinate representation of hierarchical values in the three or more types of scalabilities is generated by a series of operations corresponding to respective hierarchies in the first reference scalability, for each hierarchy in each of scalabilities other than the first and second reference scalabilities out of these three or more types of scalabilities. For that, let S be the number of scalabilities, and N_{K} (K=1, 2, 3, . . . , i−1, or i), specifically, N₁, N₂, . . . , Nᵢ₋₁, or Nᵢ in order from the smallest be the number of hierarchies in each scalability; for the total packet number given by Mathematical Expression (1) below, the number of multidimensional key element matrices generated in the encryption key generating method is given by Mathematical Expression (2) below.

$$\begin{matrix}[ Mathematical Expression 1 ] & \\ {\prod }_{i = 1}^{S} {N}_{i} & ( 1 ) \\ [ Mathematical Expression 2 ] & \\ {\prod }_{i = 1}^{S - 1} {N}_{i} & ( 2 )\end{matrix}$$

Specifically, in each of multidimensional key element matrices obtained, at least coordinate entries corresponding to respective hierarchies from the lowest to the highest in the second reference scalability in a hierarchy in the first reference scalability corresponding to one split key out of the generated split keys are assigned operation data successively obtained by repeating a hash operation on the one split key using a one-way hash function. This maintains the hierarchical nature of at least the second reference scalability in the multidimensional key element matrix obtained.

The subsequent step is to combine entries coordinately consistent among the respective multidimensional key element matrices generated by the series of operations corresponding to the respective hierarchies in the first reference scalability, for the respective hierarchies in each of the scalabilities other than the first and second reference scalabilities, so as to generate partial keys corresponding to data units in the respective hierarchies in the plural types of scalabilities. Namely, since the multidimensional key element matrices obtained are generated with the respective hierarchies of the first reference scalability, for each of hierarchies in each of the scalabilities other than the first and second reference scalabilities, the hierarchical nature of the first reference scalability is also maintained in a partial key matrix finally generated from the obtained multidimensional key element matrices.

In each of the multidimensional key element matrices generated by the series of operations corresponding to the respective hierarchies in the first reference scalability, for the respective hierarchies in each of the scalabilities other than the first and second scalabilities, coordinate entries corresponding to respective hierarchies from the lowest to the highest of the second reference scalability in a hierarchy at a lower position than respective corresponding hierarchies of the other scalability and the first reference scalability are assigned the same operation data as the operation data successively obtained with one split key assigned to the corresponding hierarchy of the first reference scalability. On the other hand, all coordinate entries corresponding to respective hierarchies from the lowest to the highest of the second reference scalability in a hierarchy at a higher position than the respective corresponding hierarchies of the other scalability and the first reference scalability are assigned operation data obtained by a hash operation with a one-way hash function on a key element in the highest hierarchy in the second reference scalability out of key elements in the hierarchy corresponding to the one split key.

Each of embodiments according to the present invention will become further fully understood by the following detailed description and accompanying drawings. These embodiments are presented by way of illustration only and should not be construed as limiting the present invention.

A further application range of this invention will become apparent from the following detailed description. It should be, however, noted that the detailed description and specific examples will be presented to explain preferred embodiments of the present invention by way of illustration only, and it is apparent that a variety of modifications and improvements within the scope of the invention are obvious to those skilled in the art in view of the detailed description.

### Effect of the Invention

According to the present invention, as described above, the partial keys for the hierarchies at subordinately higher positions are generated by making use of the one-way hash function from the master key, and, therefore, a partial key corresponding to one data unit specified by hierarchical levels in respective scalabilities cannot be generated from any partial key corresponding to a data unit at a higher hierarchical position in one of the scalabilities. Therefore, it becomes feasible to prevent collusion attacks. Since the partial keys are generated for each of combinations of two types of scalabilities as scalabilities of access control targets, it is feasible to reduce the key length of the generated partial keys.

### BRIEF DESCRIPTION OF THE DRAWINGS

FIG. 1 is a conceptual diagram for explaining a data structure of digital data with plural types of hierarchical scalabilities;

FIG. 2 is a conceptual diagram for explaining progressive orders;

FIG. 3 is a drawing showing matrix representations of data units (corresponding to respective packages of JPEG2000) of digital data with two types of three-layered scalabilities, and partial keys corresponding thereto;

FIG. 4 is a conceptual diagram for explaining the first embodiment of the encryption key generating method according to the present invention;

FIG. 5 is a conceptual diagram for explaining generation of key element matrices in the encryption key generating method of the first embodiment;

FIG. 6 is a conceptual diagram for explaining the second embodiment of the encryption key generating method according to the present invention;

FIG. 7 is a conceptual diagram for explaining generation of key element matrices in the encryption key generating method of the second embodiment;

FIG. 8 is a conceptual diagram for explaining the third embodiment of the encryption key generating method according to the present invention;

FIG. 9 is a conceptual diagram for explaining generation of key element matrices in the encryption key generating method of the third embodiment;

FIG. 10 is a conceptual diagram for explaining generation of partial keys for digital data with three or more types of hierarchical scalabilities, as the fourth embodiment of the encryption key generating method according to the present invention;

FIG. 11 is a drawing showing a hierarchy table in generation of partial keys, and a coordinate correspondence relation between partial key element matrices and a partial key matrix, in the encryption key generating method of the fourth embodiment;

FIG. 12 is a drawing for explaining an element correspondence relation between partial key element matrices and a partial key matrix in generation of partial keys, in the encryption key generating method of the fourth embodiment;

FIG. 13 is a drawing for explaining a three-dimensional matrix as an example of stereoscopic indication of coordinate entry arrangement in a multidimensional partial key matrix and a multidimensional key element matrix, and an assigning operation of split keys in the encryption key generating method (FIGS. 9 and 10) as a generalized method of the fourth embodiment;

FIG. 14 is a drawing for explaining key element generating steps corresponding to respective hierarchies of scalabilities L and R, using three-dimensional matrices of stereoscopic indications, in the encryption key generating method as the generalized method of the fourth embodiment;

FIG. 15 is a drawing for explaining key element generating steps corresponding to respective hierarchies of scalabilities R and C, using three-dimensional matrices of stereoscopic indications, in the encryption key generating method as the generalized method of the fourth embodiment;

FIG. 16 is a drawing for explaining key element generating steps corresponding to respective hierarchies of scalabilities L and C, using three-dimensional matrices of stereoscopic indications, in the encryption key generating method as the generalized method of the fourth embodiment;

FIG. 17 is a drawing for explaining an example of a method of generating split keys from a master key, in the fifth embodiment of the encryption key generating method according to the present invention;

FIG. 18 is a drawing for explaining generation steps of multidimensional key element matrices in the encryption key generating method of the fifth embodiment (generation of a multidimensional key element matrix group corresponding to the lowest hierarchy of scalability C other than reference scalabilities L and R);

FIG. 19 is a drawing for explaining generation steps of multidimensional key element matrices in the encryption key generating method of the fifth embodiment (generation of a multidimensional key element matrix group corresponding to a hierarchy higher by one hierarchy than the lowest hierarchy of scalability C other than reference scalabilities L and R); and

FIG. 20 is a drawing for explaining generation steps of multidimensional key element matrices in the encryption key generating method of the fifth embodiment (generation of a multidimensional key element matrix group corresponding to the highest hierarchy of scalability C other than reference scalabilities L and R).

### DESCRIPTION OF REFERENCE SYMBOLS

M1-M3 key element matrices; MPa-MPc partial key element matrices; MP1-MP4 partial key matrices; QM multidimensional partial key matrix; QM_{RL1}-QM_{RL4}, QM_{RC1}-QM_{RC4}, QM_{LC1}-QM_{LC3}, QM₁₋₁-QM₄₋₁, QM₁₋₂-QM₄₋₂, QM₁₋₃-QM₄₋₃ multidimensional key element matrices.

### BEST MODE FOR CARRYING OUT THE INVENTION

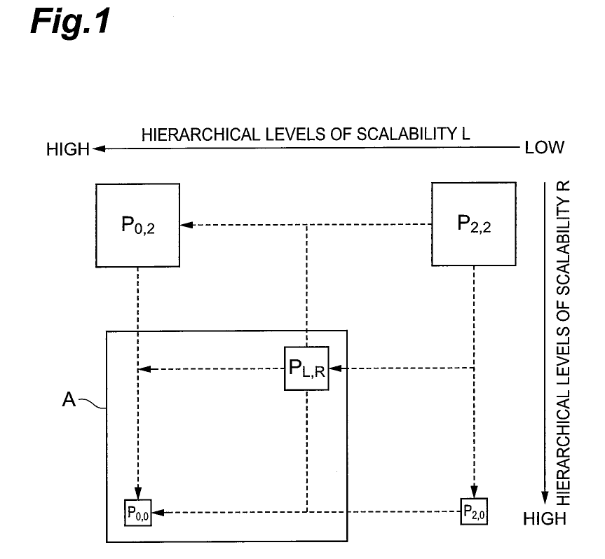

In the following, embodiments of an encryption key generating method according to the present invention will be described below in detail with reference to FIGS. 1 to 20. In the description of the drawings the same portions and the same elements will be denoted by the same reference symbols, without redundant description.

The encryption key generating method according to the present invention is to generate an encryption key used in coding and decoding of digital data with plural types of hierarchical scalabilities. Each of the embodiments will be described using a specific example of digital data with hierarchical scalabilities, as to generation of partial keys corresponding to respective packet codestreams of JPEG2000 being the international standard of image compression, for simplicity. JPEG2000 allows an order of priorities to be given to types of scalabilities. This order in a codestream is expressed as a construction order (progression order) of packets being data units. Elements to determine this progression order include four types of scalabilities, layer (L), resolution level (R), component (C), and position (P).

FIG. 1 is a conceptual diagram for explaining a data structure of digital data with plural types of hierarchical scalabilities, and shows a decoding pattern of packet codestreams in JPEG2000 when scalabilities as access control targets out of the scalabilities of JPEG2000 are limited to only the layer (L) and the resolution level (R) (a case of a grayscale picture). Specifically, in FIG. 1, the number of hierarchies N_{L} in the layer (scalability L) is 3 and the number of hierarchies N_{R} in the resolution level (scalability R) is 3. The layer is also called a quality layer and means arithmetic code data of a digital image corresponding to SNR (Signal/Noise Ratio) in reproduction of image. Since a higher layer contains information with greater effect on the image quality, the quality of a reproduced image can be improved stepwise by successively adding data of a lower layer to data of a higher layer.

In this FIG. 1, P_{i,j} (i=0, . . . , N_{L}−1; j=0, . . . , N_{R}−1; i a hierarchy number of scalability L; j a hierarchy number of scalability R) represents JPEG2000 packets with image information. When Q_{L,R} represents a JPEG2000 coded image with a certain quality, all packets P_{i,j} (i=0, . . . , L; j=0, . . . , R) within frame A in FIG. 1 have to be decoded in order to obtain Q_{L,R}. For normally reproducing the image, all the packets P_{i,j} to be decoded must be decrypted. Therefore, it is necessary to individually encrypt the packets P_{i,j}, in order to maintain the hierarchical nature in access control.

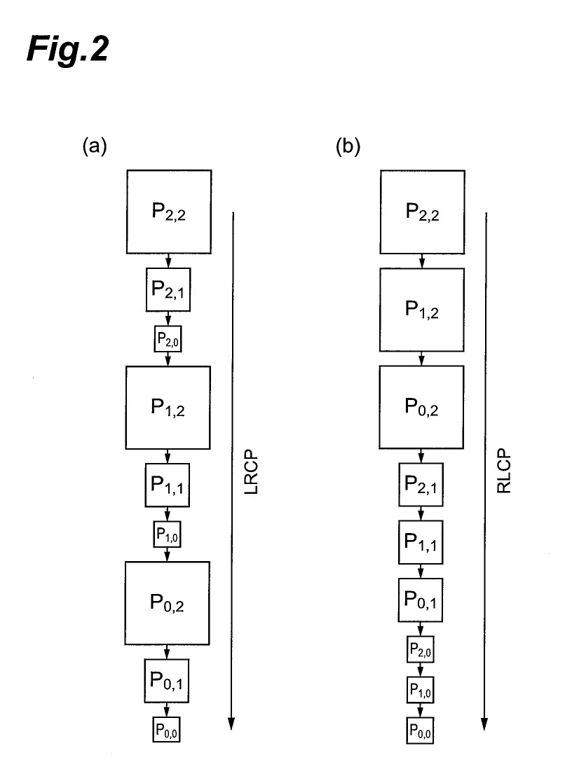

In JPEG2000 as described above, there are five types of progression orders, LRCP, RLCP, RPCL, PCRL, and CPRL, and priorities are given to respective elements in descending order from the top. FIG. 2 is a conceptual diagram for explaining progressive orders showing priority orders in decoding the JPEG2000 packet codestreams shown in FIG. 1. Particularly, in FIG. 2, the area (a) shows a decoding order in the LRCP progression order with the highest priority to scalability L (layer) and the area (b) a decoding order in the RLCP progression order with the highest priority to scalability R (resolution level).

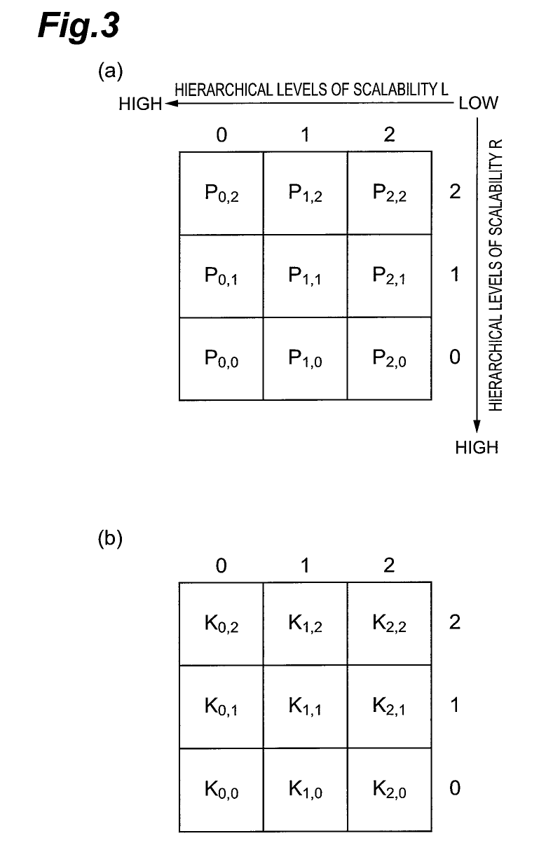

The encryption key generating method according to the present invention reduces the key length in terms of safety and easy production in management and delivery of the encryption key, and has the resistance to collusion attacks. Since the encryption key generating method handles each packet as a matrix entry specified by hierarchical levels of respective scalabilities in order to generate encryption keys for the respective JPEG2000 packets as described above, the progression orders in JPEG2000 do not matter. As an example, the area (a) of FIG. 3 shows packets P_{L,R} (L:0 (highest), 1, 2 (lowest); R:0 (highest), 1, 2 (lowest)) in a matrix representation with hierarchical levels of scalability L (layer) and hierarchical levels of scalability R (resolution level). The area (b) of FIG. 3 shows partial keys K_{L,R} (L:0, 1, 2; R:0, 1, 2) in a matrix representation corresponding to the packets P_{L,R} in the area (a) of FIG. 3.

A collusion attack herein is such an attack that two or more users illegally share their encryption keys, so as to enable reproduction of an image in a quality higher than a regularly authorized quality. Specifically, let us consider a collusion case using an example of a JPEG2000 coded image, in which a collusion is made by a user authorized to open only the highest layer (layer 0) and a user authorized to open only the highest resolution level (resolution level 0). In this case, when K_{i,j} represents an encryption key for packet P_{i,j}, one user receives encryption keys K_{0,j} (j=0, 1, 2) for three packets P_{0,j} (j=0, 1, 2) and the other user receives encryption keys K_{i,0} (i=0, 1, 2) for three packets P_{i,0} (i=0, 1, 2), as regularly authorized keys. If the resistance is not enough to collusion attacks, these users could collude and illegally generate encryption keys K_{2,2}, K_{2,1}, K_{1,2}, and K_{1,1} which are not authorized for the two users. In the encryption key generating method according to the present invention, as described in each of the embodiments below, an encryption key (partial key) for a certain packet cannot be generated from a packet in a hierarchy at a higher position in at least one scalability than that of the packet of interest, and can be generated from a packet in a hierarchy at an identical or lower position in each scalability. For this reason, the encryption key generating method according to the present invention has the resistance to collusion attacks.

### First Embodiment

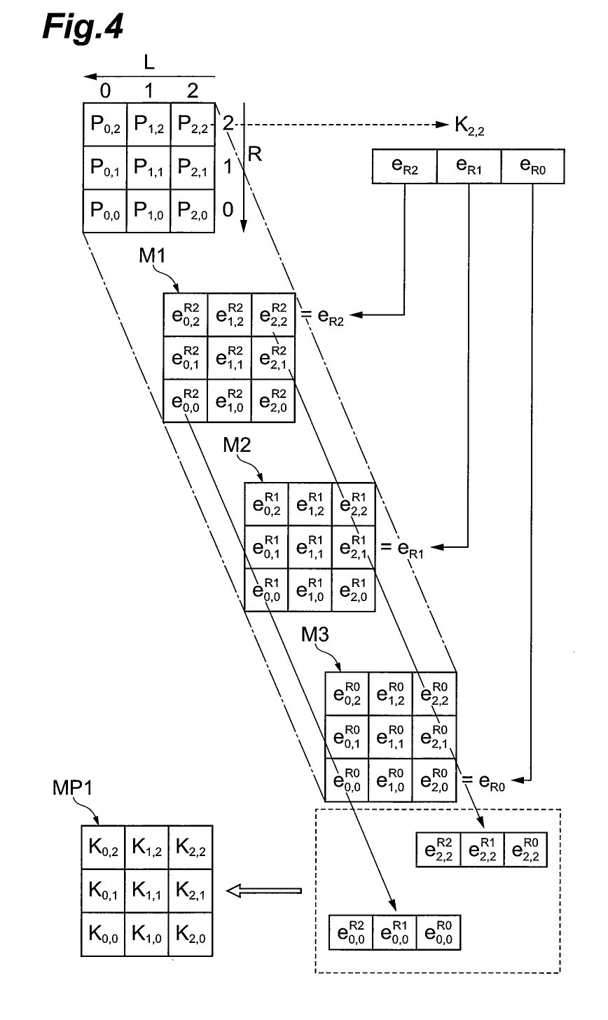

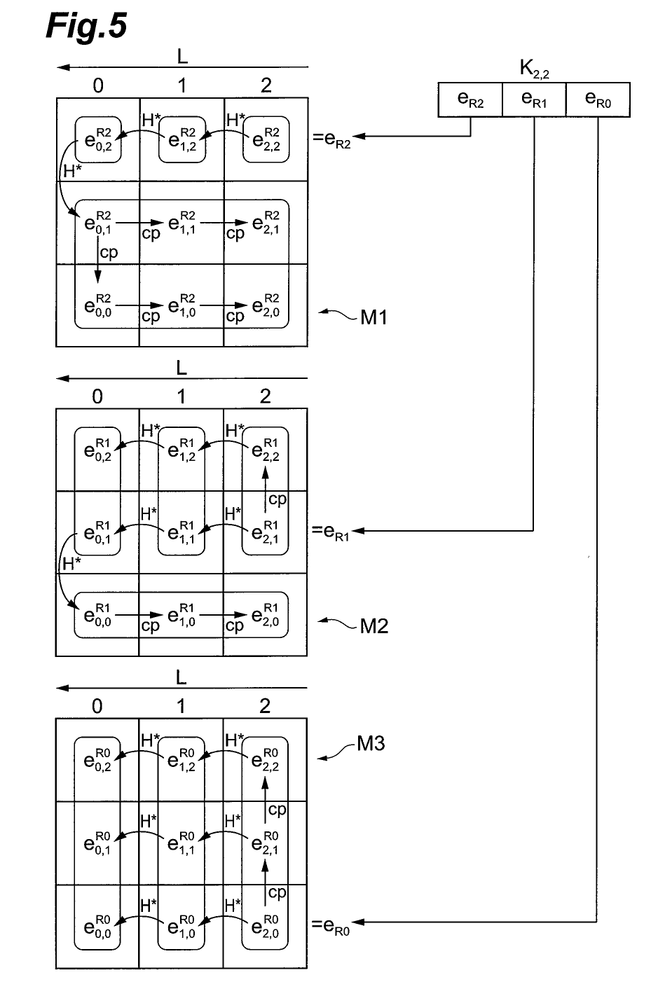

The first embodiment of the encryption key generating method according to the present invention will be described below. In this first embodiment, scalabilities as access control targets are scalability L (layer) and scalability R (resolution level), the number of hierarchies N_{L} in scalability L is 3, and the number of hierarchies N_{R} in scalability R is 3. At this time, packets in the respective hierarchies in scalabilities L and R are handled as 3×3 matrix entries P_{i,j} (i=0, 1, 2; j=0, 1, 2). FIG. 4 is a conceptual diagram for explaining the first embodiment of the encryption key generating method according to the present invention. FIG. 5 is a conceptual diagram for explaining generation of key element matrices in the encryption key generating method of the first embodiment.

A master key is a partial key corresponding to the lowest packet preliminarily managed and in the example of FIG. 4, the master key is a partial key K_{2,2} corresponding to the packet P_{2,2} in the hierarchies at the lowest position in each of scalabilities L and R. This master key K_{2,2} is divided by a smaller value (=min(N_{L},N_{R})) out of the hierarchy number N_{L} of scalability L and the hierarchy number N_{R} of scalability R.

Since in this first embodiment N_{L}=N_{R}=3, either of scalabilities L and R can be selected, and it is assumed as an example herein that scalability R is selected as a reference scalability. At this time, the master key K_{2,2} is divided by the minimum hierarchy number 3 (the number of hierarchies in scalability R) to obtain split keys e_{R2}, e_{R1}, and e_{R0}. These split keys e_{R2}, e_{R1}, and e_{R0} are root keys (keys for generation of respective matrix entries) corresponding to the respective hierarchies of scalability R, and key element matrices M1-M3 are generated for the respective hierarchies of scalability R.

Matrix entries in the respective key element matrices M1-M3 are sequentially generated from the split keys e_{R2}, e_{R1}, and e_{R0} being the corresponding root keys, as shown in FIG. 5.

First, in the key element matrix M1, as a matrix corresponding to the hierarchical level 2 (lowest hierarchy) of scalability R, the split key e_{R2} is assigned to the (2,2) entry. In the drawing, superscript R2 to each matrix entry e represents the hierarchical level of scalability R (reference scalability) corresponding to the key element matrix M1 and each subscript represents coordinates of an entry in the key element matrix M1. In this first embodiment, the entries in the key element matrix M1 will be denoted below by e^{R2}(i,j) (i=0, 1, 2; j=0, 1, 2).

Coordinate entries e^{R2}(1,2) and e^{R2}(0,2) corresponding to the respective remaining hierarchies in scalability L in the hierarchy (hierarchical level=2) in scalability R corresponding to the split key e_{R2} are assigned operation data successively obtained by repeating a hash operation on the split key e_{R2} using a one-way hash function H*. Namely, e^{R2}(1,2) is assigned the operation data of H*(e^{R2}(2,2)) and the entry e^{R2}(0,2) is assigned the operation data of H*²(e^{R2}(2,2)). This matrix operation procedure maintains the hierarchical nature of scalability L, for the hierarchical level 2 of scalability R. In this specification, the operation of n (n=2,3, . . . ) repetitions with one-way hash function H* is denoted by H*ⁿ.

On the other hand, in the key element matrix M1, all the entries e^{R2}(i,j) (i=0, 1, 2; j=0, 1) in the higher hierarchies than the hierarchical level 2 of scalability R are assigned operation data H*(e^{R2}(0,2))(=H*³(e^{R2}(2,2))) obtained by further carrying out the hash operation with the one-way hash function H* on the entry e^{R2}(0,2). The operation data at this time is a value corresponding to a packet with the hierarchy number of scalability L being −1 (which is nonexistent in fact).

The key element matrix M1 generated as described above enables the access control to the packets P_{i,2} (i=0, 1, 2), while maintaining the hierarchical nature of scalability L.

In the key element matrix M2, as a matrix corresponding to the hierarchical level 1 of scalability R, the split key e_{R1} is assigned to the (2,1) entry. In this first embodiment, the entries in the key element matrix M2 will be denoted below by e^{R1}(i,j) (i=0, 1, 2; j=0, 1, 2).

Operation data of H*(e^{R1}(2,1)) is assigned to the coordinate entry e^{R1}(1,1) and operation data of H*²(e^{R1}(2,1)) to the entry e^{R1}(0,1) corresponding to the respective remaining hierarchies in scalability L in the hierarchy (hierarchical level=1) in scalability R corresponding to the split key e_{R1}. This matrix operation procedure maintains the hierarchical nature of scalability L, for the hierarchical level 1 of scalability R.

Furthermore, in the key element matrix M2, all the entries e^{R1}(i,0) (i=0, 1, 2) in the higher hierarchy than the hierarchical level 1 of scalability R are assigned operation data H*(e^{R1}(0,1))(=H*³(e^{R1}(2,1))) obtained by further carrying out the hash operation with the one-way hash function H* on the entry e^{R1}(0,1). The operation data at this time is a value corresponding to a packet with the hierarchy number of scalability L being −1 (which is nonexistent in fact).

On the other hand, in the key element matrix M2, the entries e^{R1}(i,2) (i=0, 1, 2) in the lower hierarchy than the hierarchical level 1 of scalability R are assigned the same values as the corresponding entries e^{R1}(i,1) (i=0, 1, 2). It is synonymous with the following: the entries e^{R1}(i,2) (i=0, 1) are assigned values obtained by successively carrying out the hash operation with the one-way hash function on the entry e^{R1}(2,2) in which the value of entry e^{R1}(2,1) is copied once. In FIG. 5 and others, “CP” means copy.

The key element matrix M2 generated as described above enables the access control to the packets P_{i,1} (i=0, 1, 2), while maintaining the hierarchical nature of scalability L.

Similarly, in the key element matrix M3, as a matrix corresponding to the hierarchical level 0 (highest hierarchy) of scalability R, the split key e_{R0} is assigned to the (2,0) entry. In this first embodiment, the entries in the key element matrices M3 will be denoted below by e^{R0}(i,j) (i=0, 1, 2; j=0, 1, 2).

Operation data of H*(e^{R0}(2,0)) is assigned to the coordinate entry e^{R0}(1,0) and operation data of H*²(e^{R0}(2,0)) is assigned to the entry e^{R0}(0,0) corresponding to the respective remaining hierarchies in scalability L in the hierarchy (hierarchical level=0) in scalability R corresponding to the split key e_{R0}. This matrix operation procedure maintains the hierarchical nature of scalability L, for the hierarchical level 0 of scalability R.

Furthermore, since there is no higher hierarchy than the hierarchical level 0 of scalability R in the key element matrix M3, no further hash operation is carried out on the entry e^{R0}(0,0).

On the other hand, in the key element matrix M3, the entries e^{R0}(i,j) (i=0, 1, 2; j=1, 2) in the lower hierarchies than the hierarchical level 0 of scalability R are assigned the same values as the corresponding entries e^{R0}(i,0) (i=0, 1, 2). This is synonymous with the following: the entries e^{R0}(i,j) (i=0, 1, 2; j=1, 2) are assigned the values obtained by successively carrying out the hash operation with the one-way hash function on each of the entries e^{R0}(2,2) and e^{R0}(2,1) in which the value of the entry e^{R0}(2,0) is copied once.

In this case, the key element matrix M3 generated also enables the access control to the packets P_{i,0} (i=0, 1, 2), while maintaining the hierarchical nature of scalability L.

Subsequently, a partial key matrix MP1 is generated by combining the entries coordinately consistent among the key element matrices M1-M3 generated by the above-described matrix operation. Namely, entries in the partial key matrix MP1 serve as partial keys K_{i,j} (i=0, 1, 2; j=0, 1, 2) corresponding to the respective packets P_{i,j} (i=0, 1, 2; j=0, 1, 2). As described above, for each of the hierarchies of one scalability R (resolution level), the partial keys are generated while maintaining the hierarchical nature of the other scalability L (layer), whereby the hierarchical nature is maintained in the layer and in the resolution level. The packets P_{i,j} (i=0, 1, 2; j=0, 1, 2) are coded by the respective corresponding partial keys K_{i,j} (i=0, 1, 2; j=0, 1, 2) and the JPEG2000 packet codestreams thus encrypted are laid open to the public.

### Second Embodiment

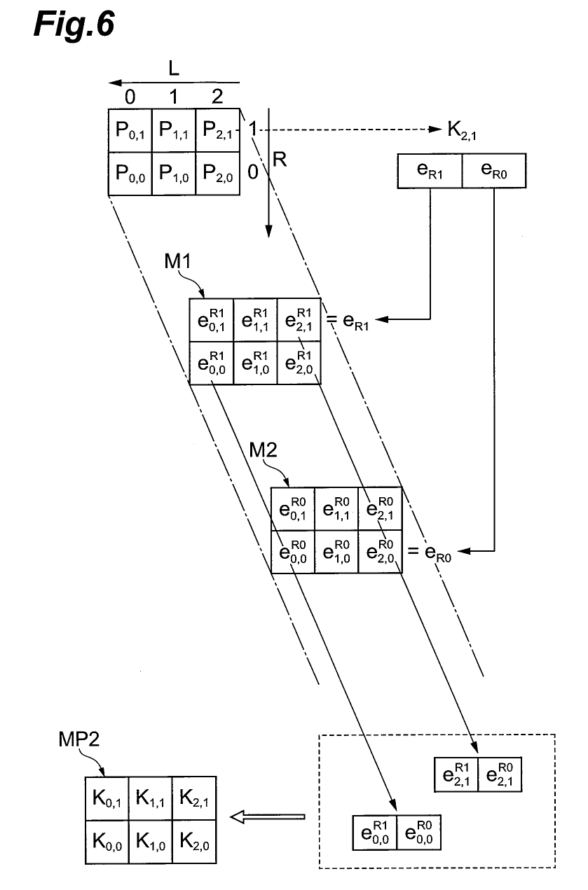

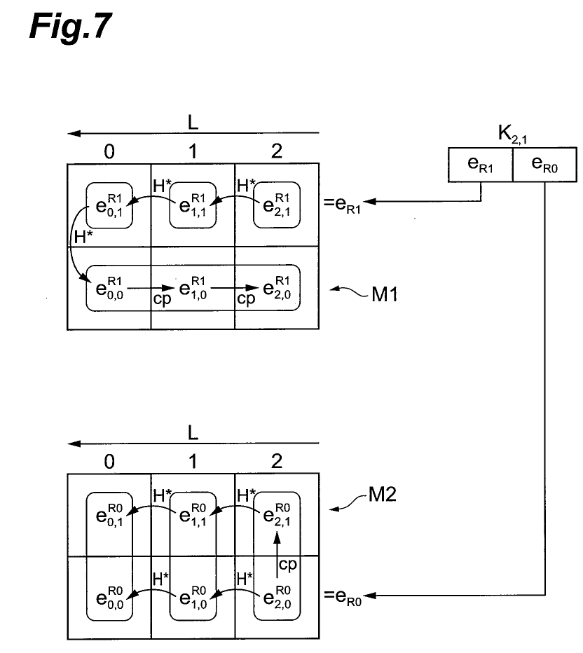

The second embodiment of the encryption key generating method according to the present invention will be described below. In this second embodiment, scalabilities as access control targets are scalability L (layer) and scalability R (resolution level), the number of hierarchies N_{L} in scalability L is 3, and the number of hierarchies N_{R} in scalability R is 2. At this time, packets in respective hierarchies in scalabilities L and R are handled as 3×2 matrix entries P_{i,j} (i=0, 1, 2; j=0, 1). FIG. 6 is a conceptual diagram for explaining the second embodiment of the encryption key generating method according to the present invention. FIG. 7 is a conceptual diagram for explaining generation of key element matrices in the encryption key generating method of the second embodiment.

The master key is a partial key corresponding to the lowest packet preliminarily managed and in the example of FIG. 6, it is an encryption key K_{2,1} corresponding to the packet P_{2,1} in the hierarchies at the lowest position in each of scalabilities L and R. This master key K_{2,1} is divided by a smaller value (=min(N_{L},N_{R})) out of the hierarchy number N_{L} of scalability L and the hierarchy number N_{R} of scalability R. Specifically, the master key K_{2,1} is divided by the hierarchy number of scalability R (minimum hierarchy number 2) to obtain split keys e_{R1} and e_{R0}. These split keys e_{R1}, e_{R0} are root keys corresponding to the respective hierarchies of scalability R and key element matrices M1, M2 are generated for the respective hierarchies of scalability R.

Matrix entries in the respective key element matrices M1, M2 are sequentially generated from the split keys e_{R1}, e_{R0} being the corresponding root keys, as shown in FIG. 7.

First, in the key element matrix M1, as a matrix corresponding to the hierarchical level 1 (lowest hierarchy) of scalability R, the split key e_{R1} is assigned to the (2,1) entry. In the drawing, superscript R1 to each matrix entry e represents the hierarchical level of scalability R (reference scalability) corresponding to the key element matrix M1, and each subscript represents coordinates of an entry in the key element matrix M1. In this second embodiment, the entries in the key element matrix M1 will be denoted below by e^{R1}(i,j) (i=0, 1, 2; j=0, 1).

Coordinate entries e^{R1}(1,1) and e^{R2}(0,1) corresponding to the respective remaining hierarchies in scalability L in the hierarchy (hierarchical level=1) in scalability R corresponding to the split key e_{R1} are assigned operation data successively obtained by repeating the hash operation on the split key e_{R1} using the one-way hash function H*. Namely, e^{R1}(1,1) is assigned the operation data of H*(e^{R1}(2,1)) and the entry e^{R1}(0,1) is assigned the operation data of H*²(e^{R1}(2,1)). This matrix operation procedure maintains the hierarchical nature of scalability L, for the hierarchical level 1 of scalability R.

On the other hand, in the key element matrix M1, all the entries e^{R1}(i,0) (i=0, 1, 2) in the higher hierarchy than the hierarchical level 1 of scalability R are assigned the operation data H*(e^{R1}(0,1))(=H*³(e^{R1}(2,1))) obtained by further carrying out the hash operation with the one-way hash function H* on the entry e^{R1}(0,1). The operation data at this time is a value corresponding to a packet with the hierarchy number of scalability L being −1 (which is nonexistent in fact).

The key element matrix M1 generated as described above enables the access control to the packets P_{i,1} (i=0, 1, 2), while maintaining the hierarchical nature of scalability L.

In the key element matrix M2, as a matrix corresponding to the hierarchical level 0 (highest hierarchy) of scalability R, the split key e_{R0} is assigned to the (2,0) entry. In this second embodiment, the entries in the key element matrix M2 will be denoted below by e^{R0}(i,j) (i=0, 1, 2; j=0, 1).

The operation data of H* (e^{R0}(2,0)) is assigned to the coordinate entry e^{R0}(1,0) and the operation data of H*²(e^{R0}(2,0)) is assigned to the entry e^{R0}(0,0) corresponding to the respective remaining hierarchies in scalability L in the hierarchy (hierarchical level=0) in scalability R corresponding to the split key e_{R0}. This matrix operation procedure maintains the hierarchical nature of scalability L, for the hierarchical level 0 of scalability R.

Furthermore, no further hash operation on the entry e^{R0}(0,0) is carried out because there is no higher hierarchy than the hierarchical level 0 of scalability R in the key element matrix M2.

On the other hand, in the key element matrix M2, the entries e^{R0}(i,1) (i=0, 1, 2) in the lower hierarchy than the hierarchical level 0 of scalability R are assigned the same values as the corresponding entries e^{R0}(i,0) (i=0, 1, 2). This is synonymous with the following: the entries e^{R0}(i,1) (i=0, 1, 2) are assigned values obtained by successively carrying out the hash operation with the one-way hash function on the entry e^{R0}(2,1) in which the value of the entry e^{R0}(2,0) is copied once. In FIG. 7 CP represents the copy operation.

In this case, the key element matrix M2 thus generated also enables the access control to the packets P_{i,0} (i=0, 1, 2), while maintaining the hierarchical nature of scalability L. In FIG. 7 and others, “CP” means copy.

The subsequent step is to combine the entries coordinately consistent between the key element matrices M1, M2 generated by the above matrix operation, to generate a partial key matrix MP2. Namely, the entries in the partial key matrix MP2 serve as partial keys K_{i,j} (i=0, 1, 2; j=0, 1) corresponding to the respective packets P_{i,j} (i=0, 1, 2; j=0, 1). As described above, for each hierarchy of one scalability R (resolution level), the partial keys are generated while maintaining the hierarchical nature of the other scalability L (layer), whereby the hierarchical nature is maintained in the layer and in the resolution level. The packets P_{i,j} (i=0, 1, 2; j=0, 1) are coded by the corresponding partial keys K_{i,j} (i=0, 1, 2; j=0, 1) and the JPEG2000 packet codestreams encrypted in this manner are laid open to the public.

### Third Embodiment

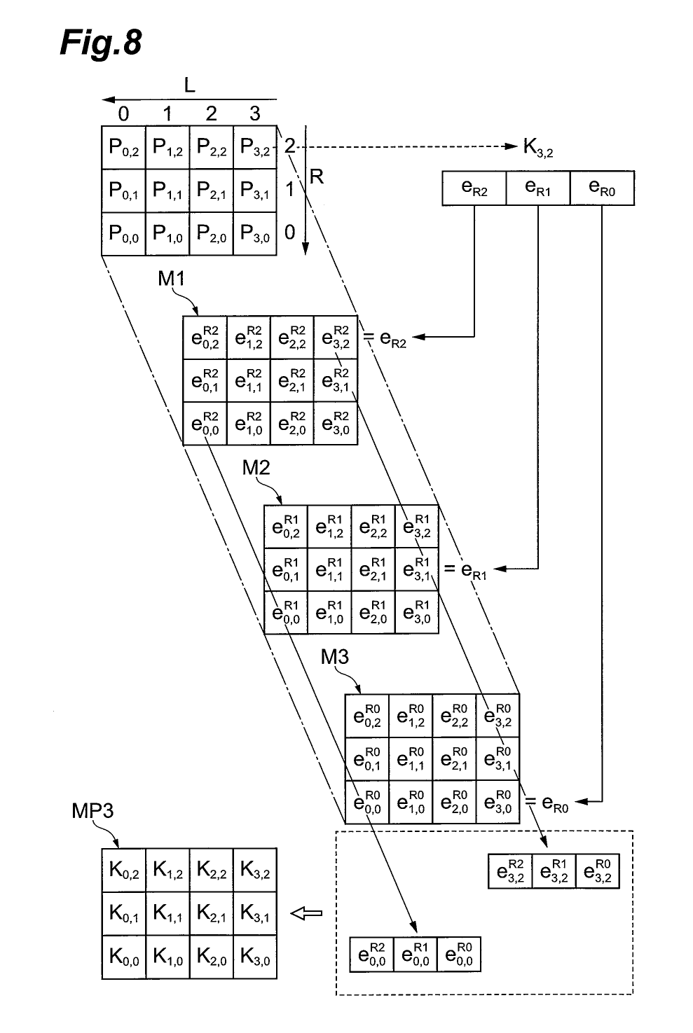

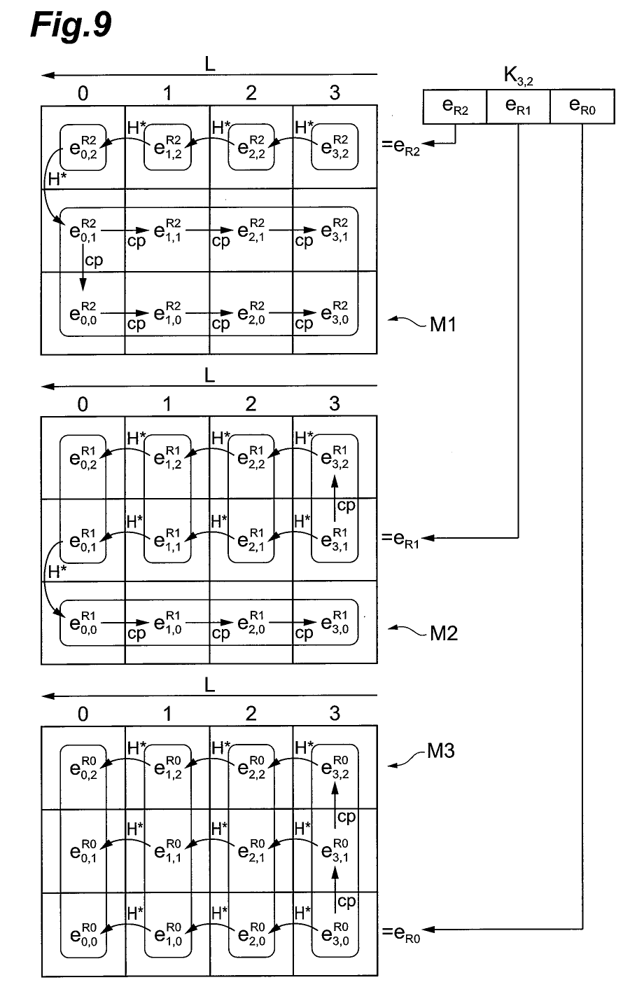

The third embodiment of the encryption key generating method according to the present invention will be described below. In this third embodiment, the scalabilities as access control targets are scalability L (layer) and scalability R (resolution level), the number of hierarchies N_{L} in scalability L is 4, and the number of hierarchies N_{R} in scalability R is 3. At this time, packets in respective hierarchies in scalabilities L and R are handled as 4×3 matrix entries P_{i,j} (i=0, 1, 2; j=0, 1, 2, 3). FIG. 8 is a conceptual diagram for explaining the third embodiment of the encryption key generating method according to the present invention. FIG. 9 is a conceptual diagram for explaining generation of key element matrices in the encryption key generating method of the third embodiment.

A master key is a partial key corresponding to the lowest packet preliminarily managed and in the example of FIG. 8, it is an encryption key K_{3,2} corresponding to the packet P_{3,2} in the hierarchies at the lowest position in each of the scalabilities L and R. This master key K_{3,2} is divided by a smaller value (=min(N_{L},N_{R})) out of the hierarchy number N_{L} of scalability L and the hierarchy number N_{R} of scalability R. Namely, the master key K_{3,2} is divided by the hierarchy number of scalability R (minimum hierarchy number 3) to obtain split keys e_{R2}, e_{R1}, and e_{R0}. These split keys e_{R2}, e_{R1}, and e_{R0} are root keys corresponding to the respective hierarchies of scalability R and key element matrices M1-M3 are generated for the respective hierarchies of scalability R.

The matrix entries in the respective key element matrices M1-M3 are successively generated from the split keys e_{R2}, e_{R1}, and e_{R0} being the corresponding root keys, as shown in FIG. 9.

First, in the key element matrix M1, as a matrix corresponding to the hierarchical level 2 (lowest hierarchy) of scalability R, the split key e_{R2} is assigned to the (3,2) entry. In the drawing, superscript R2 to each matrix entry e represents the hierarchical level of scalability R (reference scalability) corresponding to the key element matrix M1, and each subscript represents coordinates of an entry in the key element matrix M1. In this third embodiment, the entries in the key element matrix M1 will be denoted below by e^{R2}(i,j) (i=0, 1, 2, 3; j=0, 1, 2).

The coordinate entries e^{R2}(2,2), e^{R2}(1,2), and e^{R2}(0,2) corresponding to the respective remaining hierarchies in scalability L in the hierarchy (hierarchical level=2) in scalability R corresponding to the split key e_{R2} are assigned operation data successively obtained by repeating the hash operation on the split key e_{R2} using the one-way hash function H*. Specifically, e^{R2}(2,2) is assigned the operation data of H*(e^{R2}(3,2)), e^{R2}(1,2) is assigned the operation data of H*²(e^{R2}(3,2)), and the entry e^{R2}(0,2) is assigned the operation data of H*³(e^{R2}(3,2)). This matrix operation procedure maintains the hierarchical nature of scalability L, for the hierarchical level 2 of scalability R.

On the other hand, in the key element matrix M1, all the entries e^{R2}(i,j) (i=0, 1, 2, 3; j=0, 1) in the higher hierarchies than the hierarchical level 2 of scalability R are assigned operation data H*(e^{R2}(0,2))(=H*⁴(e^{R2}(3,2))) obtained by further carrying out the hash operation with the one-way hash function H* on the entry e^{R2}(0,2). The operation data at this time is a value corresponding to a packet with the hierarchy number of scalability L being −1 (which is nonexistent in fact).

The key element matrix M1 generated as described above enables the access control to the packets P_{i,2} (i=0, 1, 2, 3), while maintaining the hierarchical nature of scalability L.

In the key element matrix M2, as a matrix corresponding to the hierarchical level 1 of scalability R, the split key e_{R1} is assigned to the (3,1) entry. In this third embodiment, the entries in the key element matrix M2 will be denoted below by e^{R1}(i,j) (i=0, 1, 2, 3; j=0, 1, 2).

Operation data of H*(e^{R1}(3,1)) is assigned to the coordinate entry e^{R1}(2,1), operation data of H*²(e^{R1}(3,1)) is assigned to the entry e^{R1}(1,1), and operation data of H*³(e^{R1}(3,1)) is assigned to the entry e^{R1}(0,1), corresponding to the respective remaining hierarchies in scalability L in the hierarchy (hierarchical level=1) in scalability R corresponding to the split key e_{R1}. This matrix operation procedure maintains the hierarchical nature of scalability L, for the hierarchical level 1 of scalability R.

Furthermore, in the key element matrix M2, all the entries e^{R1}(i,0) (i=0, 1, 2, 3) in the higher hierarchy than the hierarchical level 1 of scalability R are assigned operation data H*(e^{R1}(0,1)) (=H*⁴(e^{R1}(3,1))) obtained by further carrying out the hash operation with the one-way hash function H* on the entry e^{R1}(0,1). The operation data at this time is a value corresponding to a packet with the hierarchy number of scalability L being −1 (which is nonexistent in fact).

On the other hand, in the key element matrix M2, the entries e^{R1}(i,2) (i=0, 1, 2, 3) in the lower hierarchy than the hierarchical level 1 of scalability R are assigned the same values as the corresponding entries e^{R1}(i,1) (i=0, 1, 2, 3). This is synonymous with the following: the entries e^{R1}(i,2) (i=0, 1, 2) are assigned values obtained by successively carrying out the hash operation with the one-way hash function on the entry e^{R1}(3,2) in which the value of the entry e^{R1}(3,1) is copied once. In FIG. 9 and others, “CP” means copy.

The key element matrix M2 generated as described above enables the access control to the packets P_{i,1} (i=0, 1, 2, 3), while maintaining the hierarchical nature of scalability L.

Similarly, in the key element matrix M3, as a matrix corresponding to the hierarchical level 0 (highest hierarchy) of scalability R, the split key e_{R0} is assigned to the (3,0) entry. In this third embodiment, the entries in the key element matrix M3 will be denoted below by e^{R0}(i,j) (i=0, 1, 2, 3; j=0, 1, 2).

Operation data of H*(e^{R0}(3,0)) is assigned to the coordinate entry e^{R0}(2,0), operation data of H*²(e^{R0}(3,0)) is assigned to the entry e^{R0}(1,0), and operation data of H*³(e^{R0}(3,0)) is assigned to the entry e^{R0}(0,0), corresponding to the respective remaining hierarchies in scalability L in the hierarchy (hierarchical level=0) in scalability R corresponding to the split key e_{R0}. This matrix operation procedure maintains the hierarchical nature of scalability L, for the hierarchical level 0 of scalability R.

Furthermore, no further hash operation is carried out on the entry e^{R0}(0,0) because there is no higher hierarchy than the hierarchical level 0 of scalability R in the key element matrix M3.

On the other hand, in the key element matrix M3, the entries e^{R0}(i,j) (i=0, 1, 2, 3; j=1, 2) in the lower hierarchies than the hierarchical level 0 of scalability R are assigned the same values as the corresponding entries e^{R0}(i,0) (i=0, 1, 2, 3). This is synonymous with the following: the entries e^{R0}(i,j) (i=0, 1, 2, 3; j=1, 2) are assigned the values obtained by successively carrying out the hash operation with the one-way hash function on each of the entries e^{R0}(3,2) and e^{R0}(3,1) in which the value of entry e^{R0}(3,0) is copied once. In FIG. 9 CP indicates the copy operation.

In this case, the key element matrix M3 thus generated enables the access control to the packets P_{i,0} (i=0, 1, 2, 3), while maintaining the hierarchical nature of scalability L.

The subsequent step is to combine the entries coordinately consistent among the key element matrices M1-M3 generated by the above-described matrix operation, to generate a partial key matrix MP3. Namely, entries in the partial key matrix MP3 serve as partial keys K_{i,j} (i=0, 1, 2, 3; j=0, 1, 2) corresponding to the respective packets P_{i,j} (i=0, 1, 2, 3; j=0, 1, 2). As described above, for each of the hierarchies in one scalability R (resolution level), the partial keys are generated while maintaining the hierarchical nature of the other scalability L (layer), whereby the hierarchical nature is maintained in the layer and in the resolution level. The packets P_{i,j} (i=0, 1, 2, 3; j=0, 1, 2) are coded by the respective corresponding partial keys K_{i,j} (i=0, 1, 2, 3; j=0, 1, 2) and the JPEG2000 packet codestreams thus encrypted are laid open to the public.

(Evaluation of Resistance to Collusion Attacks)

In the following, the encryption keys (partial keys corresponding to the packets in the respective hierarchies) generated by the encryption key generating methods of the first to third embodiments configured as described above will be evaluated as to the resistance to collusion attacks.

It is first assumed in this evaluation that data to be coded is JPEG2000 data with scalability L having the hierarchy number N_{L} and scalability R (resolution level) having the hierarchy number N_{R}.

Partial keys K_{i,j} for the JPEG2000 packets P_{i,j} (i=0, 1, . . . , N_{L}−1; j=0, 1, . . . , N_{R}−1) are subordinately generated with the one-way hash function H*, using a partial key K_{NL-1,NR-1} for the lowest packet P_{NL-1,NR-1} as a master key. The concepts of superordinate and subordinate of hierarchies are the same as in FIG. 1. Namely, the partial keys K_{i,j} must be subordinately generated from partial keys K_{a1,b1} corresponding to packets P_{a1,b1} (a1=i, i+1, . . . , N_{L-1}; b1=j, j−1, . . . , N_{R-1}) in all the hierarchies lower than or identical to the hierarchy of packet P_{i,j} in each of the scalabilities L, R. Under this condition, in order to prevent the partial keys K_{i,j} from being illegally generated by a collusion attack from any partial key K_{a2,b2} corresponding to packet P_{a2,b2} (a2=0, 1, . . . , i−1; b2=0, 1, . . . , j−1) in a hierarchy at a higher position than packet P_{i,j} in each of the scalabilities L, R, at least one of elements constituting the partial keys K_{i,j} must be an element corresponding to a packet in a lower hierarchy than the partial key K_{a2,b2}.

Let us assume, for example, N_{R}<N_{L}. Elements e^{Rj}_{i,j} in partial key K_{i,j} for all the packets P_{i,j} (i=0, 1, . . . , N_{L}−1) in the hierarchy j (0≦j≦N_{R}−1) of scalability R are subordinately generated by the hash operation H*^{(NL-1-i)}(e_{Rj}) with the one-way hash function H*, from the element e_{Rj} as a root key. At this time, hash operation values H*^{(NL-1-i)}(e_{Rj}) in the higher hierarchy in the key element matrix Mj are directly reflected (or copied) into corresponding elements e^{Rj}_{i,b1} in partial key K_{i,b1} for all packets P_{i,b1} (i=0, 1, . . . , N_{L}−1) in a lower hierarchy b1 (<j) of scalability R. On the other hand, a hash operation value H*^{NL}(e_{Rj}) is assigned to elements e^{Rj}_{i,b2} in partial key K_{i,b2} for all packets P_{i,b2} (i=0, 1, . . . , N_{L}−1) in a higher hierarchy b2 (>j) in scalability R.

For this reason, a partial key in a higher hierarchy is reflected in at least some of elements constituting a partial key in a lower hierarchy, while any elements in a partial key in a lower hierarchy are not reflected in elements constituting a partial key in a higher hierarchy. Namely, the partial keys generated by the encryption key generating method of the present invention do not allow any partial key in a lower hierarchy to be generated from a partial key in a higher hierarchy, and, therefore, they have the resistance to collusion attacks.

(Generation of Encryption Keys in Decryption)

The below will describe generation of encryption keys (partial keys corresponding to respective packets allowed) in decryption. In the foregoing encryption key generation, each of partial keys in hierarchies at higher positions was subordinately generated from the only managed master key. On the occasion of decryption, partial keys in a hierarchy at each higher position are similarly subordinately generated from a master key, but a user receives only a delivered decryption key for the lowest packet in a packet group authorized to open.

Specifically, in the case of NL=NR=3, as shown in FIG. 1, a user requesting a grayscale picture Q_{L,R} (0≦L≦N_{L} and 0≦R≦N_{R}) up to scalability L (layer) and scalability R (resolution level), is authorized to open an image with JPEG2000 packet codestream P_{L,R} as the lowest packet (packet in hierarchies at the lowest position in each of the scalabilities L, R) and receives a key K_{L,R} (0≦L≦2 and 0≦R≦2) for the packet. When the user is allowed to view the coded picture Q_{L,R} in FIG. 1, decryption keys (decoding keys) corresponding to respective packets P in a frame A ((N_{L}−R+1)×(N_{R}−L+1)) are generated by making use of the key K_{L,R} corresponding to the coded picture Q_{L,R}. In this case, the key element matrices M1-M3 corresponding to split keys e^{R2}, e^{R1}, and e^{R0} generated from the key K_{L,R} are also (N_{L}−R+1)×(N_{R}−L+1) matrices.

The following will explain a case where the user is allowed to view a coded picture Q_{1,1} in FIG. 1. In this case, the key generation corresponds to a part of FIG. 5, and decryption keys (decoding keys) corresponding to respective packets P_{1,0}, P_{0,1}, and P_{0,0} in the frame A are generated by making use of the key K_{1,1} corresponding to the coded picture Q_{1,1}.

For that, on the user side the received partial key K_{1,1} as a master key is first divided by the number of hierarchies in scalability R (i.e., by three) to generate three split keys e^{R2}, e^{R1}, and e^{R0}.

Subsequently, a key element matrix is generated for each of the three hierarchies in scalability R. Among the three split keys e^{R2}, e^{R1}, and e^{R0}, a split key in a lower corresponding hierarchy of scalability R than the corresponding hierarchy of the received key K_{1,1} is hash operation data with the hierarchical level of the other scalability L being −1. In this case, therefore, the same value as the corresponding partial key is preliminarily assigned to all entries in the key element matrix.

First, in generation of the 2×2 key element matrix M1 corresponding to the hierarchy 2 of scalability R, the partial key e^{R2} is hash operation data corresponding to the hierarchy −1 of scalability L. Namely, since the hierarchy (hierarchical level: 2) corresponding to the split key e^{R2} of scalability R is lower than the hierarchy (hierarchical level: 1) of scalability R corresponding to the received key K_{1,1}, the value of the split key e^{R2} is the hash operation value with the hierarchical level of scalability L being −1. In this case, the same value as the split key e^{R2} (with the hierarchical level of scalability L being −1) is assigned to all the matrix entries e^{R2}(0,1), e^{R2}(1,1), e^{R2}(0,0), and e^{R2}(1,0) in the 2×2 key matrix M1 corresponding to the split key e^{R2}.

Next, in generation of the 2×2 key element matrix M2 corresponding to the hierarchy 1 of scalability R, the value of the split key e^{R1} is first assigned to the e^{R1}(1,1) entry. The entry e^{R1}(0,1) in the higher hierarchy of scalability L is assigned operation data H*(e^{R1}(1,1)) of the hash operation with the one-way hash function H*. Furthermore, hash operation data H*²(e^{R2}(1,1)) with the hierarchical level of scalability L: −1 is assigned to each of the entries e^{R1}(1,0) and e^{R1}(0,0) corresponding to the higher hierarchy (hierarchical level: 0) than the hierarchy (hierarchical level: 1) corresponding to the split key e^{R1} in scalability R. Conversely, no hash operation is carried out because there is no lower hierarchy (hierarchical level: 2) than the hierarchy (hierarchical level: 1) corresponding to the split key e^{R1} in scalability R.

On the other hand, in generation of the 2×2 key element matrix M3 corresponding to the hierarchy 0 of scalability R, there is no higher hierarchy (hierarchical level: −1) than the hierarchy (hierarchical level: 0) corresponding to the split key e^{R0} in scalability R. Therefore, the value of the split key e^{R0} is first assigned to the e^{R0}(1,0) entry. The entry e^{R0}(0,0) in the higher hierarchy of scalability L is assigned operation data H*(e^{R1}(1,0)) of the hash operation with the one-way hash function H*. Conversely, for the lower hierarchy (hierarchical level: 1) than the hierarchy (hierarchical level: 0) corresponding to the split key e^{R0} in scalability R, the value of the entry e^{R0}(1,0) is copied into the e^{R0}(1,1) entry and the hash operation is successively carried out based on this copy value. Namely, the entry e^{R0}(0,1) in the higher hierarchy of scalability L is assigned operation data H*(e^{R0}(1,1)) of the hash operation with the one-way hash function H*.

By combining the entries coordinately consistent among the 2×2 key element matrices M1-M3 corresponding to the respective hierarchies of scalability R generated as described above, decryption keys K_{1,0}, K_{0,1}, K_{0,0} corresponding to the packets P_{1,0}, P_{0,1}, P_{0,0} are generated from the master key K_{1,1}.

As described above, a partial key for a certain packet is not generated from a packet in a higher hierarchy in at least one scalability than the packet of interest, but can be generated from any packet in an equivalent or lower hierarchy in each of scalabilities. For this reason, the partial keys have the resistance to collusion attacks.

### Fourth Embodiment

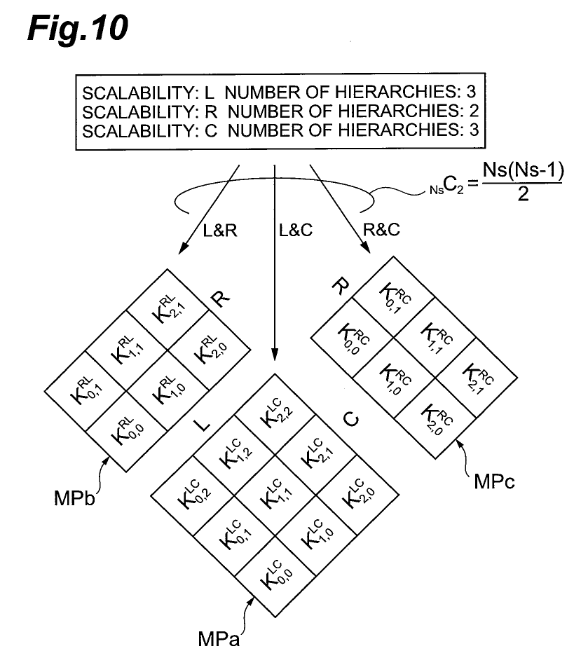

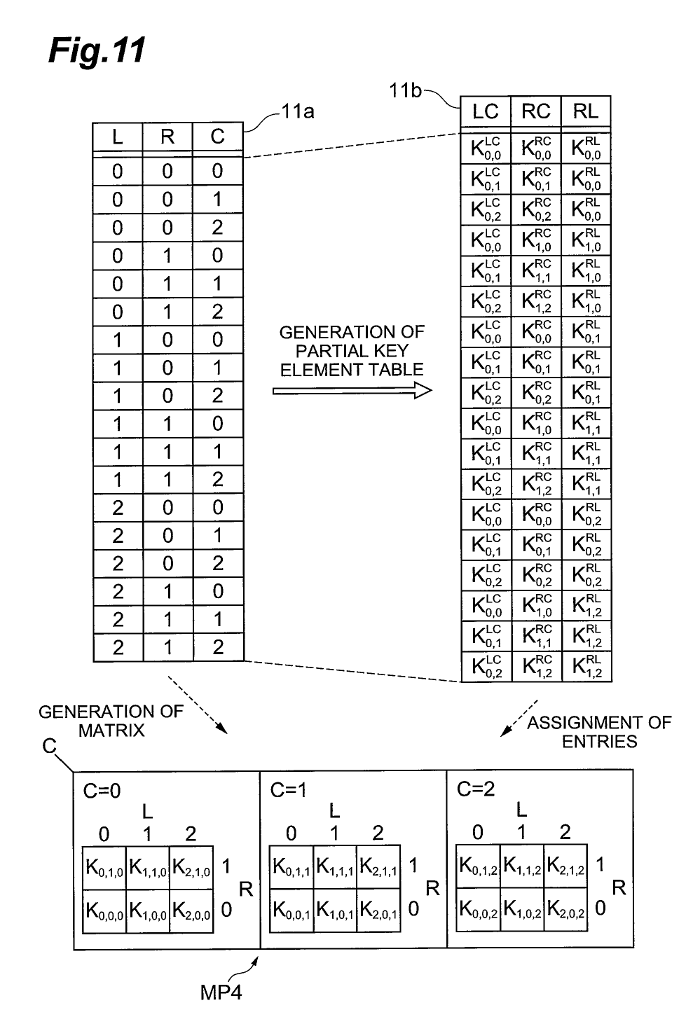

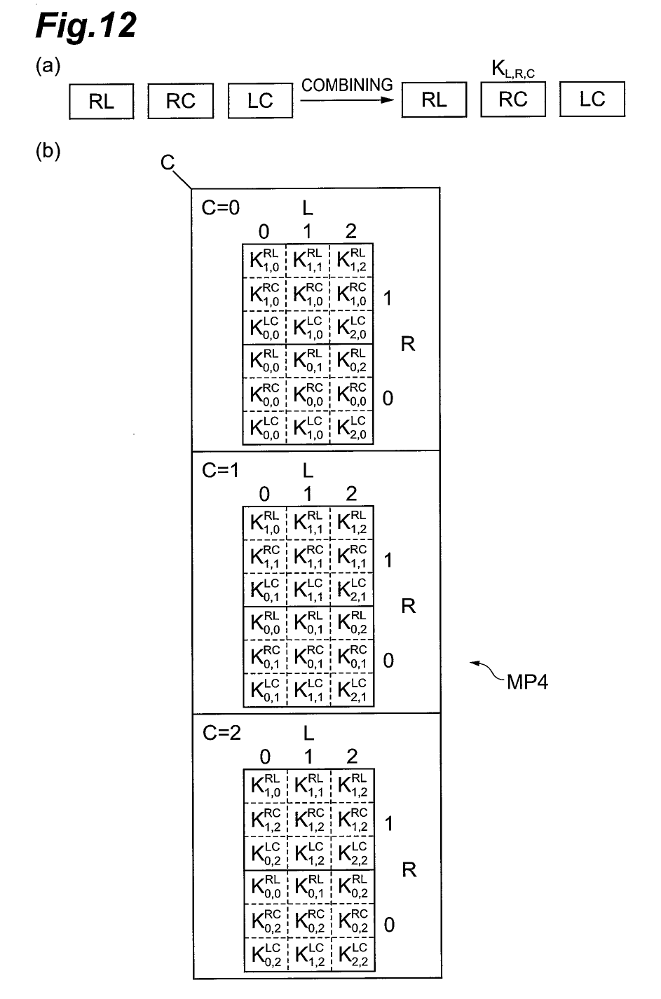

FIG. 10 is a conceptual diagram for explaining generation of partial keys for digital data with three or more types of hierarchical scalabilities, as the fourth embodiment of the encryption key generating method according to the present invention. FIG. 11 is a drawing showing a hierarchy table 11a in the partial key generation of FIG. 10, and a coordinate correspondence relation between partial key element matrices MPa-MPc and a partial key matrix MP4. FIG. 12 is a drawing for explaining an element correspondence relation between partial key element matrices MPa-MPc and a partial key matrix MP4 in the partial key generation of FIG. 10.

When there are three or more types of scalabilities as access control targets, a first conceivable method is to repeat the aforementioned key generation procedure as a minimum processing unit for combinations of two types of scalabilities. In this case, where the number of scalabilities as access control targets is N_{S}, the number of repetitions of the minimum processing unit is given by _{NS}C₂(=(N_{S}(N_{S}−1))/2).

In the example shown in FIG. 10, the encryption keys to be generated are those corresponding to respective packets in digital data having L (layer) with three hierarchies, R (resolution level) with two hierarchies, and C (component) with three hierarchies, as three types of scalabilities. In this case, the following three partial key element matrices are successively generated through much the same operation process as in the above-described first to third embodiments: partial key element matrix MPb (entry K^{RL}(0,0)-entry K^{RL}(2,1)) for a set of scalabilities R and L; partial key element matrix MPc (entry K^{RC}(0,0)-entry K^{RC}(2,1)) for a set of scalabilities R and C; partial key element matrix MPa (entry K^{LC}(0,0)-entry K^{LC}(2,2)) for a set of scalabilities L and C.

On that occasion, as shown in FIG. 11, the hierarchy table 11a showing all combinations of hierarchical values in scalabilities L, R, and C is also generated. This hierarchy table 11a provides a coordinate representation of partial key matrix MP4 whose entries are partial keys corresponding to data units in respective hierarchies in scalabilities L, R, and C, by hierarchical value groups of respective combinations. Furthermore, this hierarchy table 11a shows a relation between types of scalabilities and hierarchical values and it is possible to specify the entries in the partial key element matrices MPa-MPc generated for all the combinations of scalabilities, from this relation. Namely, a partial key element table 11b is generated as a table corresponding to all the combinations of hierarchical values in the hierarchy table 11a.

The key combinations listed in the partial key element table 11b generated in this manner correspond to the hierarchical value combinations in the hierarchy table 11a showing coordinates of respective entries in the partial key matrix MP4. Each entry K_{L,R,C} (L=0, 1, 2; R=0, 1; C=0, 1, 2) in the partial key matrix MP4 is obtained by combining key elements K^{RL}_{R,L}, K^{RC}_{R,C}, and K^{LC}_{L,C} constituting one combination in the partial key element table 11b, as shown in the area (a) of FIG. 12. Therefore, the partial key matrix MP4 is obtained by combining the key elements in the partial key element table 11b corresponding to one combination (cf. the area (b) of FIG. 12), one by one for all the combinations in the hierarchy table 11a showing the coordinates of respective entries in the partial key matrix MP4.

Each entry in the partial key matrix MP4 obtained in this manner is an encryption key corresponding to each packet in the digital data having L (layer) with three hierarchies, R (resolution level) with two hierarchies, and C (component) with three hierarchies as the scalabilities. Namely, each entry in the partial key matrix MP4 is a partial key corresponding to a packet specified by hierarchical values of the scalabilities indicating coordinates of the entry.

In cases where there are three or more types of scalabilities as access control targets, the partial keys thus obtained have the resistance to collusion attacks as in the case of two types of scalabilities.

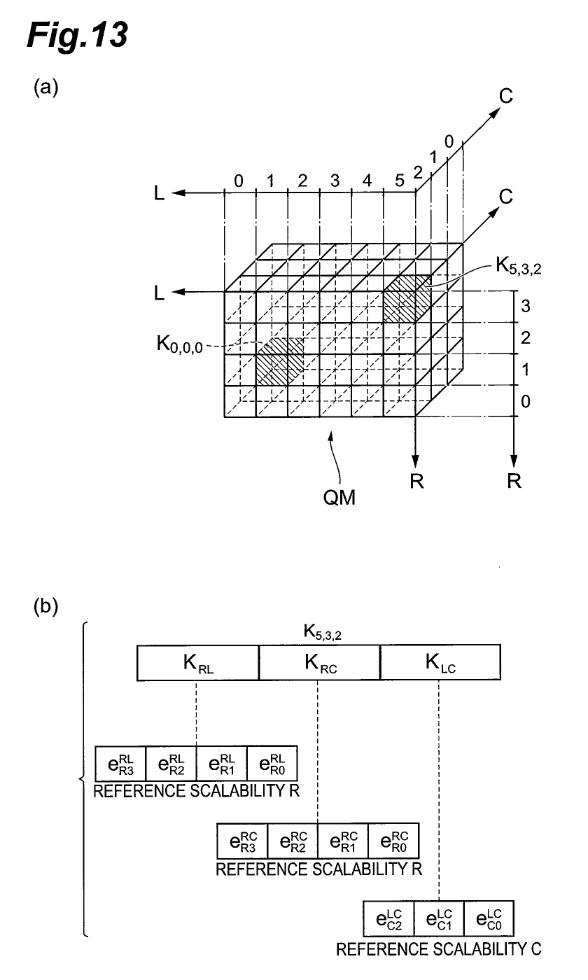

The above encryption key generating method of the fourth embodiment was described using the two-dimensional matrix representation as in the first to third embodiments, and the following will explain the encryption key generating method as a generalized method of the fourth embodiment in a stereoscopic state using a three-dimensional matrix representation. It is assumed in the description below that the access control targets are scalabilities L, R, and C, the number of hierarchies N_{L} in the scalability L (layer) is 6, the number of hierarchies N_{R} in the scalability R (resolution level) is 4, and the number of hierarchies N_{C} in the scalability C (component) is 3. In this case, packets in the respective hierarchies in scalabilities L, R, and C are handled as 6×4×3 matrix entries P_{i,j,k} (i=0, 1, 2, 3, 4, 5; j=0, 1, 2, 3; k=0, 1, 2), as shown in the area (a) of FIG. 13. The area (a) of FIG. 13 is a stereoscopic representation of arrangement of coordinate entries in a three-dimensional partial key matrix QM (the same also applies to a three-dimensional key element matrix).

As shown in the area (a) of FIG. 13, a master key is the coordinate entry K_{5,3,2} corresponding to the lowest hierarchies of the respective scalabilities L, R, and C. Furthermore, the coordinate entry K_{0,0,0} is a coordinate entry corresponding to the highest hierarchies of the respective scalabilities L, R, and C.

In the case where the 6×4×3 three-dimensional partial key matrix QM as in the area (a) of FIG. 13 is generated according to the aforementioned encryption key generating method of the fourth embodiment, the lowest partial key K_{5,3,2} is first divided by the number of repetitions, _{NS}C₂, of the minimum processing unit carried out for two types of scalabilities, to generate master keys K_{RL}, K_{RC}, and K_{LC} for the minimum processing unit of each set. Here the master key K_{RL} is a master key for generation of key elements as to the scalabilities L and R. The master key K_{RC} is a master key for generation of key elements as to the scalabilities R and C. Furthermore, the master key K_{LC} is a master key for generation of key elements as to the scalabilities L and C (cf. the area (b) of FIG. 13).

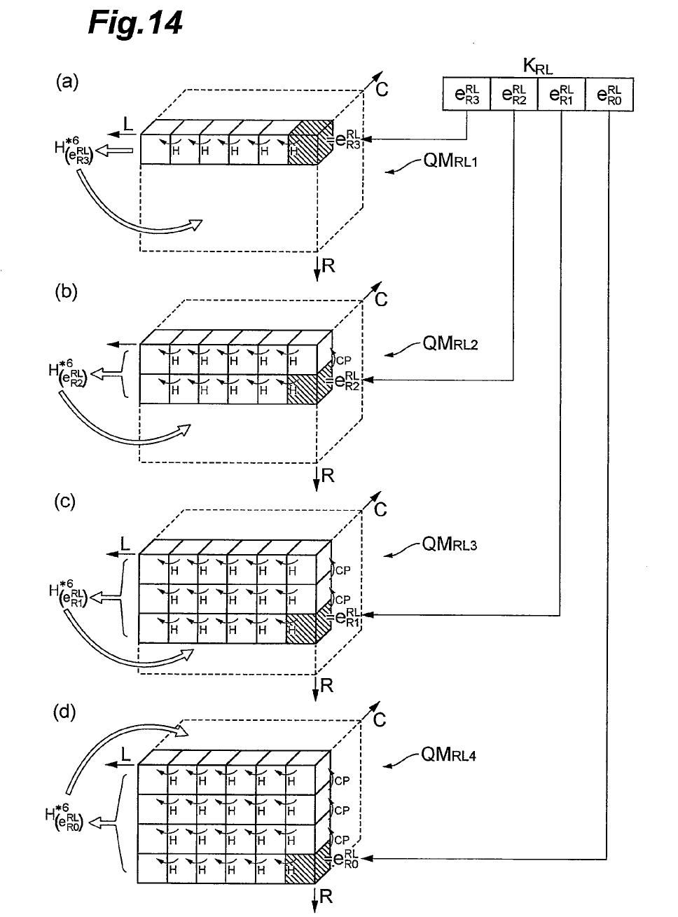

FIG. 14 is a drawing for explaining key element generating steps corresponding to the respective hierarchies of scalabilities L and R, using three-dimensional matrices in stereoscopic indication, in the encryption key generating method as the generalized method of the fourth embodiment. In the minimum processing unit about scalabilities L and R, the reference scalability is R, and the master key K_{RL} is divided by the hierarchy number 4 of the scalability R to obtain four split keys e^{RL}_{R3}, e^{RL}_{R2}, e^{RL}_{R1}, and e^{RL}_{R0} (cf. the area (b) of FIG. 13).

First, the split key e^{RL}_{R3} is assigned to the coordinate entry P_{5,3,2} (the hatched portion in the area (a) of FIG. 14) in the three-dimensional matrix, and then the hash operation on the split key e^{RL}_{R3} using the one-way hash function H is carried out in order from the lowest hierarchy to the highest hierarchy of scalability L. Namely, every time the hash operation is carried out, resultant operation data is assigned to a corresponding coordinate entry (all entries located in a region surrounded by solid lines in the area (a) of FIG. 14). At this time, operation data H*⁵(e^{RL}_{R3}) is assigned to the coordinate entry corresponding to the highest hierarchy of scalability L. On the other hand, each of coordinate entries (all entries located in a region surrounded by dashed lines in the area (a) of FIG. 14) except for the coordinate entries P_{L=0-5,R=3,C=2} assigned the operation data is assigned operation data H*⁶(e^{RL}_{R3}) obtained by further carrying out the hash operation with the one-way hash function H on the operation data H*⁵(e^{RL}_{R3}) assigned to the coordinate entry corresponding to the highest hierarchy of scalability L. The above operations generate a three-dimensional key element matrix QM_{RL1}.

Subsequently, the split key e^{RL}_{R2} is assigned to the coordinate entry P_{5,2,2} (the hatched portion in the area (b) of FIG. 14) in the three-dimensional matrix, and then this split key e^{RL}₂ is copied (CP) once into the coordinate entry P_{5,3,2}. Then, for each of hierarchy 3 and hierarchy 2 of scalability R, the hash operation on the split key e^{RL}_{R2} using the one-way hash function H is carried out in order from the lowest hierarchy to the highest hierarchy of scalability L. Namely, every time the hash operation is carried out, resultant operation data is assigned to a corresponding coordinate entry (all entries located in a region surrounded by solid lines in the area (b) of FIG. 14). At this time, operation data H*⁵(e^{RL}_{R2}) is assigned to the coordinate entry corresponding to the highest hierarchy of scalability L. On the other hand, each of the coordinate entries (all entries located in a region surrounded by dashed lines in the area (b) of FIG. 14) except for the coordinate entries P_{L=0-5,R=2-3,C=2} assigned the operation data is assigned operation data H*⁶(e^{RL}_{R2}) obtained by further carrying out the hash operation with the one-way hash function H on the operation data H*⁵(e^{RL}_{R2}) assigned to the coordinate entry corresponding to the highest hierarchy of scalability L. The above operations generate a three-dimensional key element matrix QM_{RL2}.

Furthermore, a three-dimensional key element matrix QM_{RL3} shown in the area (c) of FIG. 14 is also generated in the same manner as above by the hash operation on the split key e^{RL}_{R1} (assigned as the coordinate entry P_{5,1,2} indicated by hatching). In the area (c) of FIG. 14, H indicates the hash operation and CP the copy operation of operation data between coordinate entries. Furthermore, a three-dimensional key element matrix QM_{RL4} is also generated by the hash operation on the split key e^{RL}_{R0} (assigned as the coordinate entry P_{5,0,2} indicated by hatching), as shown in the area (d) of FIG. 14.

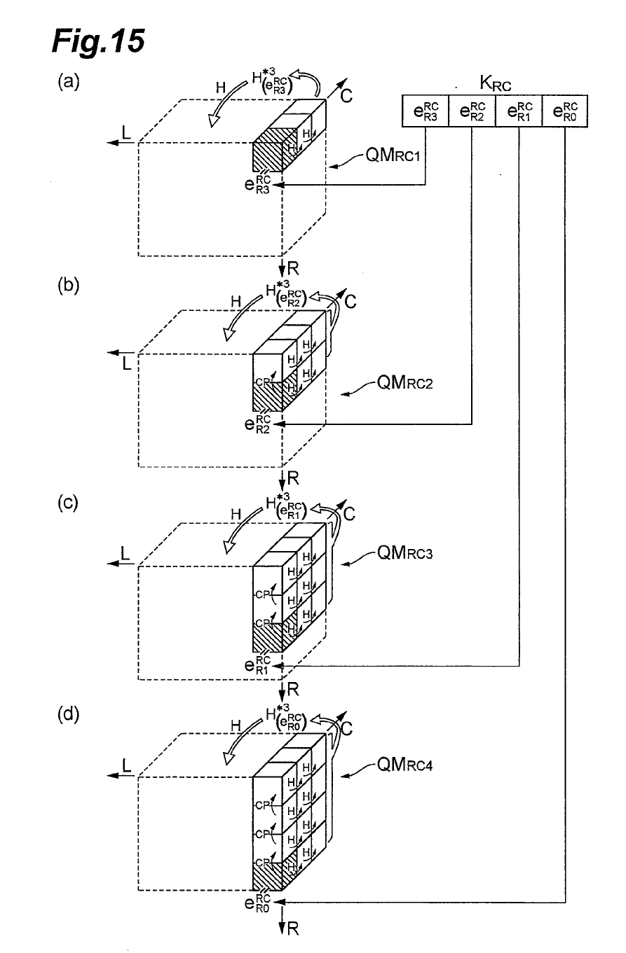

Next, FIG. 15 is a drawing for explaining key element generating steps corresponding to the respective hierarchies of scalabilities R and C, using a three-dimensional matrix in stereoscopic indication, in the encryption key generating method as the generalized method of the fourth embodiment. In the minimum processing unit about the scalabilities R and C, the reference scalability is R, and the master key K_{RC} is divided by the hierarchy number 4 of the scalability R to obtain four split keys e^{RC}_{R3}, e^{RC}_{R2}, e^{RC}_{R1}, and e^{RC}_{R0} (cf. the area (b) of FIG. 13).

The split key e^{RC}_{R3} is assigned to the coordinate entry P_{5,3,2} (the hatched portion in the area (a) of FIG. 15) in the three-dimensional matrix, and then the hash operation on the split key e^{RC}_{R3} using the one-way hash function H is carried out in order from the lowest hierarchy to the highest hierarchy of scalability C. Namely, every time the hash operation is carried out, resultant operation data is assigned to a corresponding coordinate entry (all entries located in a region surrounded by solid lines in the area (a) of FIG. 15). At this time, operation data H*²(e^{RC}_{R3}) is assigned to the coordinate entry corresponding to the highest hierarchy of scalability C. On the other hand, each of coordinate entries (all entries located in a region surrounded by dashed lines in the area (a) of FIG. 15) except for the coordinate entries P_{L=5,R=3,C=0-2} assigned the operation data is assigned operation data H*³(e^{RC}_{R3}) obtained by further carrying out the hash operation with the one-way hash function H on the operation data H*²(e^{RC}_{R3}) assigned to the coordinate entry corresponding to the highest hierarchy of scalability C. The above operations generate a three-dimensional key element matrix QM_{RC1}.

A three-dimensional key element matrix QM_{RC2} shown in the area (b) of FIG. 15 is generated by repeating the copy operation of the split key e^{RC}₂ (assigned as the coordinate entry P_{5,2,2} indicated by hatching) into the lower hierarchy than the hierarchy 2 of the reference scalability R, and the hash operation from the lowest hierarchy to the highest hierarchy of scalability C (hash operation on the split key e^{RC}_{R2} using the one-way hash function H). Similarly, a three-dimensional key element matrix QM_{RC3} shown in the area (c) of FIG. 15 is also generated by repeating the copy operation of the split key e^{RC}_{R1} (assigned as the coordinate entry P_{5,1,2} indicated by hatching) into each of the lower hierarchies than the hierarchy 1 of the reference scalability R, and the hash operation from the lowest hierarchy to the highest hierarchy of scalability C (hash operation on the split key e^{RC}_{R1} using the one-way hash function H). Furthermore, a three-dimensional key element matrix QM_{RC4} shown in the area (d) of FIG. 15 is also generated by repeating the copy operation of the split key e^{RC}_{R0} (assigned as the coordinate entry P_{5,0,2} indicated by hatching) into each of the lower hierarchies than the hierarchy 0 (highest hierarchy) of the reference scalability R, and the hash operation from the lowest hierarchy to the lowest hierarchy of scalability C (hash operation on the split key e^{RC}_{R0} using the one-way hash function H).

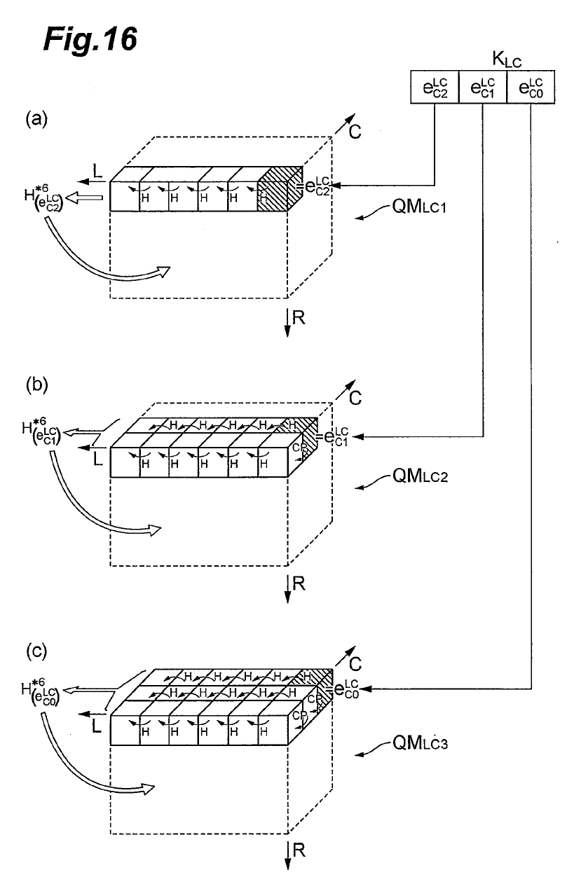

FIG. 16 is a drawing for explaining key element generating steps corresponding to the respective hierarchies of scalabilities L and C, using a three-dimensional matrix in stereoscopic indication, in the encryption key generating method as the generalized method of the fourth embodiment. In the minimum processing unit about the scalabilities L and C, the reference scalability is C, and the master key K_{LC} is divided by the hierarchy number 3 of the scalability C to obtain three split keys e^{LC}_{C2}, e^{LC}_{C1}, and e^{LC}_{C0} (cf. the area (b) of FIG. 13).

The split key e^{LC}_{C2} is assigned to the coordinate entry P_{5,3,2} (the hatched portion in the area (a) of FIG. 16) in the three-dimensional matrix, and then the hash operation on the split key e^{LC}_{C2} using the one-way hash function H is carried out in order from the lowest hierarchy to the highest hierarchy of scalability L. Namely, every time the hash operation is carried out, resultant operation data is assigned to a corresponding coordinate entry (all entries located in a region surrounded by solid lines in the area (a) of FIG. 16). At this time, operation data H*⁵(e^{LC}_{C2}) is assigned to the coordinate entry corresponding to the highest hierarchy of scalability L. On the other hand, each of coordinate entries (all entries located in a region surrounded by dashed lines in the area (a) of FIG. 16) except for the coordinate entries P_{L=0-5,R=3,C=2} assigned the operation data is assigned operation data H*⁶(e^{LC}_{C2}) obtained by further carrying out the hash operation with the one-way hash function H on the operation data H*⁵(e^{LC}_{C2}) assigned to the coordinate entry corresponding to the highest hierarchy of scalability L. The above operations generate a three-dimensional key element matrix QM_{LC1}.

A three-dimensional key element matrix QM_{LC2} shown in the area (b) of FIG. 16 is generated by repeating the copy operation of the split key e^{LC}_{C1} (assigned as the coordinate entry P_{5,3,1} indicated by hatching) into the lower hierarchy than the hierarchy 1 of the reference scalability C, and the hash operation from the lowest hierarchy to the highest hierarchy of scalability L (hash operation on the split key e^{LC}_{C1} using the one-way hash function H). Similarly, a three-dimensional key element matrix QM_{LC3} shown in the area (c) of FIG. 16 is also generated by repeating the copy operation of the split key e^{LC}_{C0} (assigned as the coordinate entry P_{5,3,0} indicated by hatching) into each of the lower hierarchies than the hierarchy 0 (highest hierarchy) of the reference scalability C, and the hash operation from the lowest hierarchy to the highest hierarchy of scalability L (hash operation on the split key e^{LC}_{C0} using the one-way hash function H).

A three-dimensional partial key matrix QM by the encryption key generating method as the generalized method of the fourth embodiment is obtained by combining the coordinate entries at the same positions in the three-dimensional key element matrices QM_{RL1}-QM_{RL4}, QM_{RC1}-QM_{RC4}, QM_{LC1}-QM_{LC3} shown of FIGS. 14 to 16, which were generated by repetitions of the above-described hash operation.

### Fifth Embodiment

Since in the above-described encryption key generating method of the fourth embodiment the minimum processing unit is definitely the partial key generating procedure with two types of scalabilities, the resultant partial keys are vulnerable to collusion attacks by three or more persons with increase in the number of hierarchies in each scalability (e.g., there are a plurality of coordinate lines with the same partial key in a multidimensional partial key matrix like the three-dimensional partial key matrix QM in the area (a) of FIG. 13). Therefore, the fifth embodiment proposes the encryption key generating method sufficiently resistant to collusion attacks by three or more persons. This encryption key generating method of the fifth embodiment will also be described with reference to the three-dimensional partial key matrix QM shown in the area (a) of FIG. 13, and it is assumed that the access control targets are scalabilities L, R, and C, the number of hierarchies N_{L} in the scalability L (layer) is 6, the number of hierarchies N_{R} in the scalability R (resolution level) is 4, and the number of hierarchies N_{C} in the scalability C (component) is 3. At this time, packets in respective hierarchies in scalabilities L, R, and C are handled as 6×4×3 matrix entries P_{i,j,k} (i=0, 1, 2, 3, 4, 5; j=0, 1, 2, 3; k=0, 1, 2). The master key prepared is the coordinate entry K_{5,3,2} corresponding to the lowest hierarchies of the respective scalabilities L, R, and C, as shown in the area (a) of FIG. 13 (the coordinate entry K_{0,0,0} is the coordinate entry corresponding to the highest hierarchies of the respective scalabilities L, R, and C).

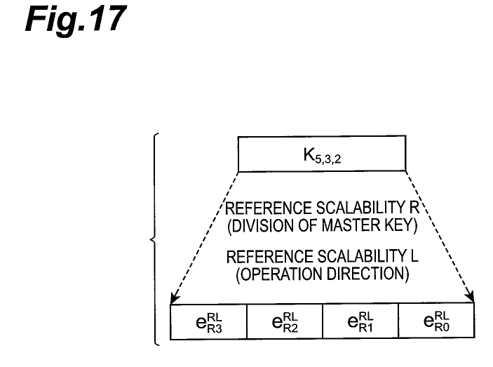

First, the encryption key generating method of the fifth embodiment includes preliminarily setting two types of scalabilities as reference scalabilities out of the three or more types of scalabilities, as shown in FIG. 17. In the example shown in FIG. 17, scalabilities L and R are set as reference scalabilities. Particularly, the reference scalability R (first reference scalability) is a scalability for generating split keys from the prepared master key K_{5,3,2}, and the prepared master key is divided by the hierarchy number 4 of this reference scalability R to generate four split keys e^{RL}_{R3}, e^{RL}_{R2}, e^{RL}_{R1}, and e^{RL}_{R0} corresponding to the respective hierarchies of the reference scalability R. On the other hand, the reference scalability L is a scalability for defining an operation direction of the hash operation with the one-way hash function as described above. FIG. 17 is a drawing for explaining an example of the method of generating the split keys from the master key, in the fifth embodiment of the encryption key generating method according to the present invention.

In the encryption key generating method of the fifth embodiment, a three-dimensional key element matrix in coordinate representation with hierarchical values in three or more types of scalabilities L, R, C (cf. the area (a) of FIG. 13) is generated by a series of hash operations corresponding to the respective hierarchies of the reference scalability R, for each hierarchy of the scalability C except for the reference scalabilities L, R. In this fifth embodiment, therefore, with three types of scalabilities L, R, and C (hierarchy number of L: 6; hierarchy number of R: 4; hierarchy number of C: 3), the total packet number given by Mathematical Expression (1) above is 72, and the number of generated three-dimensional key element matrices given by Mathematical Expression (2) above is 12.

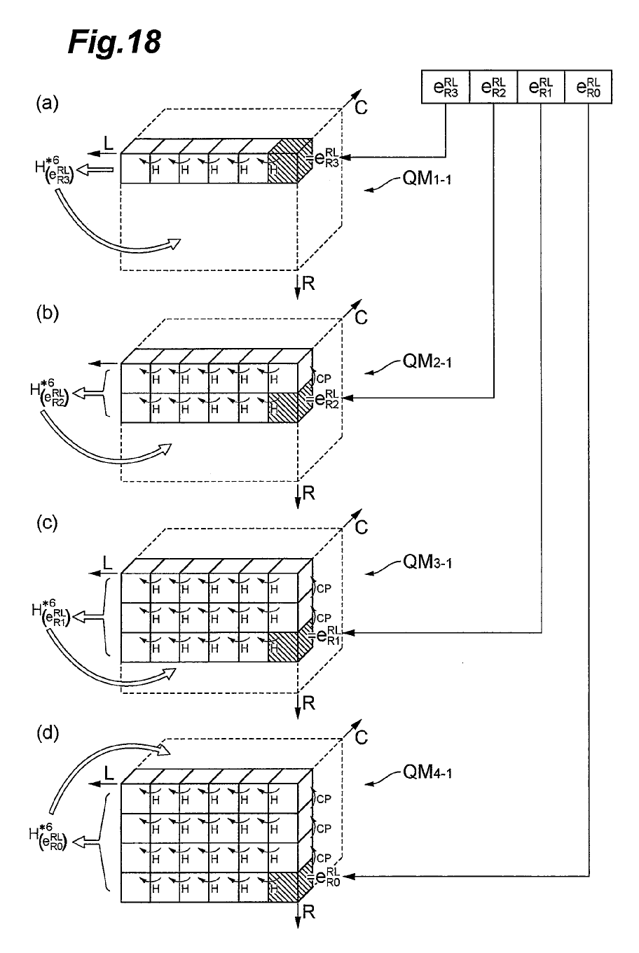

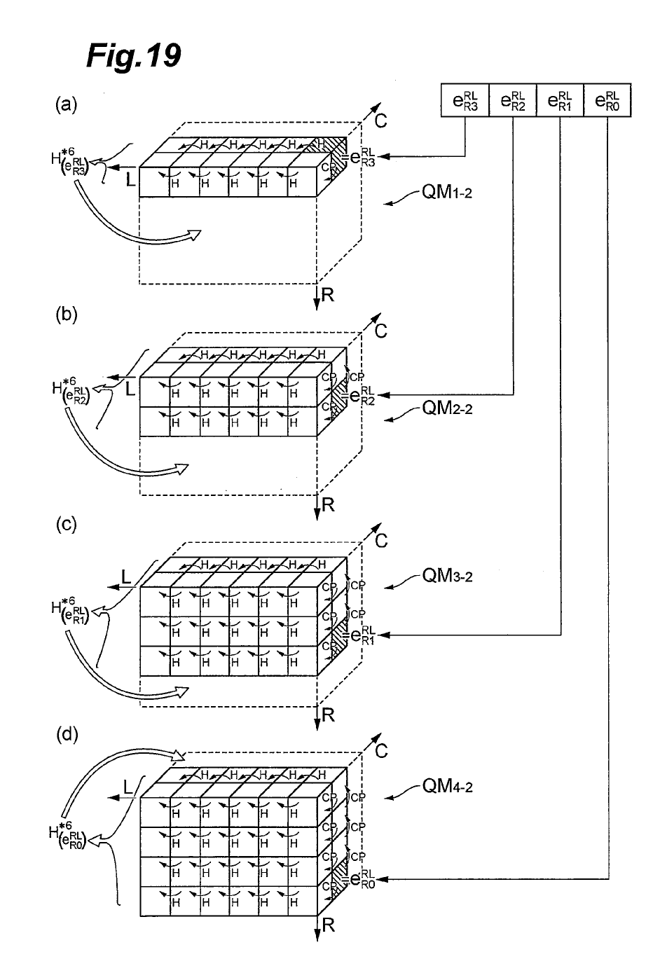

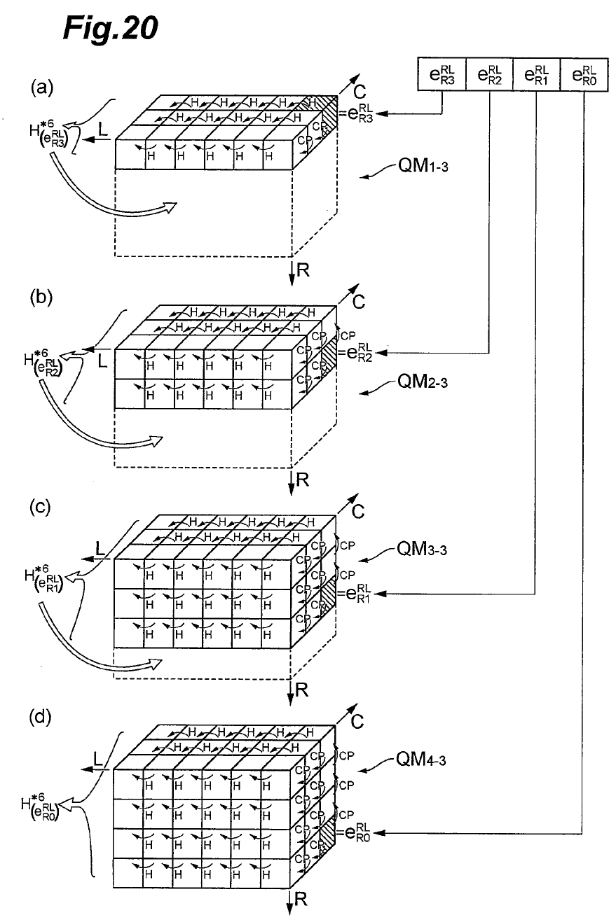

FIGS. 18 to 20 are drawings for explaining steps of generating the three-dimensional key element matrices by the encryption key generating method of the fifth embodiment. Particularly, FIG. 18 shows the three-dimensional key element matrices QM₁₋₁, QM₂₋₁, QM₃₋₁, and QM₄₋₁ generated by assigning predetermined coordinate entries the operation data obtained by successively carrying out the hash operation from the lowest hierarchy to the highest hierarchy of scalability L, for the lowest hierarchy (hierarchy 2) of the scalability C other than the reference scalabilities L and R. FIG. 19 shows the three-dimensional key element matrices QM₁₋₂, QM₂₋₂, QM₃₋₂, and QM₄₋₂ generated by assigning predetermined coordinate entries the operation data obtained by successively carrying out the hash operation from the lowest hierarchy to the highest hierarchy of the scalability L, for the hierarchy (hierarchy 1) higher by one hierarchy than the lowest hierarchy of the scalability C other than the reference scalabilities L and R. FIG. 20 shows the three-dimensional key element matrices QM₁₋₃, QM₂₋₃, QM₃₋₃, and QM₄₋₃ generated by assigning predetermined coordinate entries the operation data obtained by successively carrying out the hash operation from the lowest hierarchy to the highest hierarchy of the scalability L, for the highest hierarchy (hierarchy 0) of the scalability C other than the reference scalabilities L and R.

First, the area (a) of FIG. 18 shows the three-dimensional key element matrix QM₁₋₁ generated using the split key e^{RL}_{R3} corresponding to the lowest hierarchy of the reference scalability R, for the lowest hierarchy 2 of the scalability C other than the reference scalabilities L and R.

The split key e^{RL}_{R3} is assigned to the coordinate entry P_{5,3,2} (the hatched portion in the area (a) of FIG. 18) in the three-dimensional matrix, and then the hash operation on the split key e^{RL}_{R3} using the one-way hash function H is carried out in order from the lowest hierarchy to the highest hierarchy of scalability L. Namely, every time the hash operation is carried out, resultant operation data is assigned to a corresponding coordinate entry (all entries located in a region surrounded by solid lines in the area (a) of FIG. 18). At this time, operation data H*⁵(e^{RL}_{R3}) is assigned to the coordinate entry corresponding to the highest hierarchy of the scalability L. On the other hand, each of the coordinate entries (all entries located in a region surrounded by dashed lines in the area (a) of FIG. 18) except for the coordinate entries P_{L=0-5,R=3,C=2} assigned the operation data is assigned operation data H*⁶(e^{RL}_{R3}) obtained by further carrying out the hash operation with the one-way hash function H on the operation data H*⁵(e^{RL}_{R3}) assigned to the coordinate entry corresponding to the highest hierarchy of the scalability L. The above operations generate the three-dimensional key element matrix QM₁₋₁.

The area (b) of FIG. 18 shows the three-dimensional key element matrix QM₂₋₁ generated using the split key e^{RL}_{R2} corresponding to the hierarchy 2 of the reference scalability R (hierarchy higher by one hierarchy than the lowest hierarchy), for the lowest hierarchy 2 of the scalability C other than the reference scalabilities L and R.

In generation of this three-dimensional key element matrix QM₂₋₁, the split key e^{RL}_{R2} is assigned to the coordinate entry P_{5,2,2} (the hatched portion in the area (b) of FIG. 18) in the three-dimensional matrix. At this time, the split key e^{RL}_{R2} is copied (CO) once into the coordinate entry P_{5,3,2}. Then, for each of hierarchy 3 and hierarchy 2 of scalability R, the hash operation on the split key e^{RL}_{R2} using the one-way hash function H is carried out in order from the lowest hierarchy to the highest hierarchy of the scalability L. Namely, every time the hash operation is carried out, resultant operation data is assigned to a corresponding coordinate entry (all entries located in a region surrounded by solid lines in the area (b) of FIG. 18). At this time, operation data H*⁵(e^{RL}_{R2}) is assigned to the coordinate entry corresponding to the highest hierarchy of the scalability L. On the other hand, each of the coordinate entries (all entries located in a region surrounded by dashed lines in the area (b) of FIG. 18) except for the coordinate entries P_{L=0-5,R=2-3,C=2} assigned the operation data is assigned operation data H*⁶(e^{RL}_{R2}) obtained by further carrying out the hash operation with the one-way hash function H on the operation data H*⁵(e^{RL}_{R2}) assigned to the coordinate entry corresponding to the highest hierarchy of the scalability L. The above operations generate the three-dimensional key element matrix QM₂₋₁.

The three-dimensional key element matrix QM₃₋₁ shown in the area (c) of FIG. 18 is also generated in the same manner as in the generation of the three-dimensional key element matrices QM₁₋₁ and QM₂₋₁, by repeating the copy operation of the split key e^{RL}_{R1} (assigned as the coordinate entry P_{5,1,2} indicated by hatching) into each of the lower hierarchies than the hierarchy 1 of the reference scalability R, and the hash operation from the lowest hierarchy to the highest hierarchy of the scalability L (hash operation on the split key e^{RL}_{R1} using the one-way hash function H). Similarly, the three-dimensional key element matrix QM₄₋₁ shown in the area (d) of FIG. 18 is also generated by repeating the copy operation of the split key e^{RL}_{R0} (assigned as the coordinate entry P_{5,0,2} indicated by hatching) into each of the lower hierarchies than the hierarchy 0 (highest hierarchy) of the reference scalability C, and the hash operation from the lowest hierarchy to the highest hierarchy of the scalability L (hash operation on the split key e^{RL}_{R0} using the one-way hash function H).

Next, the area (a) of FIG. 19 shows the three-dimensional key element matrix QM₁₋₂ generated using the split key e^{RL}_{R3} corresponding to the lowest hierarchy of the reference scalability R, for the hierarchy 1 (hierarchy higher by one hierarchy than the lowest hierarchy) of the scalability C other than the reference scalabilities L and R.

The split key e^{RL}_{R3} is assigned to the coordinate entry P_{5,3,2} (the hatched portion in the area (a) of FIG. 19) in the three-dimensional matrix, and then this split key e^{RL}_{R3} is copied (CP) once into the coordinate entry P_{5,3,1}. Then, for each of hierarchy 2 (lowest hierarchy) and hierarchy 1 (hierarchy higher by one hierarchy than the lowest hierarchy) of the scalability C, the hash operation on the split key e^{RL}_{R3} using the one-way hash function H is carried out in order from the lowest hierarchy to the highest hierarchy of the scalability L. Namely, every time the hash operation is carried out, resultant operation data is assigned to a corresponding coordinate entry (all entries located in a region surrounded by solid lines in the area (a) of FIG. 19). At this time, operation data H*⁵(e^{RL}_{R3}) is assigned to each coordinate entry corresponding to the highest hierarchy of the scalability L. On the other hand, each of the coordinate entries (all entries located in a region surrounded by dashed lines in the area (a) of FIG. 19) except for the coordinate entries P_{L=0-5,R=3,C=2-3} assigned the operation data is assigned operation data H*⁶(e^{RL}_{R3}) obtained by further carrying out the hash operation with the one-way hash function H on the operation data H*⁵(e^{RL}_{R3}) assigned to the coordinate entry corresponding to the highest hierarchy of the scalability L. The above operations generate the three-dimensional key element matrix QM₁₋₂.

The are (b) of FIG. 19 shows the three-dimensional key element matrix QM₂₋₂ generated using the split key e^{RL}_{R2} corresponding to the hierarchy 2 (hierarchy higher by one hierarchy than the lowest hierarchy) of the reference scalability R, for the hierarchy 1 of the scalability C other than the reference scalabilities L and R.

In generation of this three-dimensional key element matrix QM₂₋₂, the split key e^{RL}_{R2} is assigned to the coordinate entry P_{5,2,1} (the hatched portion in the area (b) of FIG. 19) in the three-dimensional matrix. At this time, the split key e^{RL}_{R2} is copied (CP) once into the coordinate entries P_{5,2-3,1-2}. Then, for each of hierarchy 3 and hierarchy 2 of the scalability R in hierarchy 2 and hierarchy 1 of the scalability C, the hash operation on the split key e^{RL}_{R2} using the one-way hash function H is carried out in order from the lowest hierarchy to the highest hierarchy of the scalability L. Namely, every time the hash operation is carried out, resultant operation data is assigned to a corresponding coordinate entry (all entries located in a region surrounded by solid lines in the area (b) of FIG. 19). At this time, operation data H*⁵(e^{RL}_{R2}) is assigned to each coordinate entry corresponding to the highest hierarchy of the scalability L. On the other hand, each of the coordinate entries (all entries located in a region surrounded by dashed lines in the area (b) of FIG. 19) except for the coordinate entries P_{L=0-5,R=2-3,C=1-2} assigned the operation data is assigned operation data H*⁶(e^{RL}_{R2}) obtained by further carrying out the hash operation with the one-way hash function H on the operation data H*⁵(e^{RL}_{R2}) assigned to the coordinate entry corresponding to the highest hierarchy of the scalability L. The above operations generate the three-dimensional key element matrix QM₂₋₂.

The three-dimensional key element matrix QM₃₋₂ shown in the area (c) of FIG. 19 is also generated in the same manner as in the generation of the three-dimensional key element matrices QM₁₋₂ and QM₂₋₂ described above, by repeating the copy operation of the split key e^{RL}_{R1} (assigned as the coordinate entry P_{5,1,1} indicated by hatching) into each of the lower hierarchies than the hierarchy 1 of the reference scalability R and the lower hierarchy than the hierarchy 1 of the scalability C, and the hash operation from the lowest hierarchy to the highest hierarchy of the scalability L (hash operation on the split key e^{RL}_{R1} using the one-way hash function H). Similarly, the three-dimensional key element matrix QM₄₋₂ shown in the area (d) of FIG. 19 is also generated by repeating the copy operation of the split key e^{RL}_{R0} (assigned as the coordinate entry P_{5,0,1} indicated by hatching) into each of the lower hierarchies than the hierarchy 0 (highest hierarchy) of the reference scalability R and the lower hierarchy than the hierarchy 1 of the reference scalability C, and the hash operation from the lowest hierarchy to the highest hierarchy of the scalability L (hash operation on the split key e^{RL}_{R0} using the one-way hash function H).

Furthermore, the area (a) of FIG. 20 shows the three-dimensional key element matrix QM₁₋₃ generated using the split key e^{RL}_{R3} corresponding to hierarchy 3 (lowest hierarchy) of the reference scalability R, for hierarchy 0 (highest hierarchy) of the scalability C other than the reference scalabilities L and R.

The split key e^{RL}_{R3} is assigned to the coordinate entry P_{5,3,0} (the hatched portion in the area (a) of FIG. 20) in the three-dimensional matrix, and then this split key e^{RL}_{R3} is copied (CP) once into each of the coordinate entries P_{5,3,C=1,2}. Then, for each of hierarchy 2 (lowest hierarchy) to hierarchy 0 (highest hierarchy) of the scalability C in hierarchy 3 (highest hierarchy) of the reference scalability R, the hash operation on the split key e^{RL}_{R3} using the one-way hash function H is carried out in order from the lowest hierarchy to the highest hierarchy of the scalability L. Namely, every time the hash operation is carried out, resultant operation data is assigned to a corresponding coordinate entry (all entries located in a region surrounded by solid lines in the area (a) of FIG. 20). At this time, operation data H*⁵(e^{RL}_{R3}) is assigned to each coordinate entry corresponding to the highest hierarchy of the scalability L. On the other hand, each of the coordinate entries (all entries located in a region surrounded by dashed lines in the area (a) of FIG. 20) except for the coordinate entries P_{L=0-5,R=3,C=0-2} assigned the operation data is assigned operation data H*⁶(e^{RL}_{R3}) obtained by further carrying out the hash operation with the one-way hash function H on the operation data H*⁵(e^{RL}_{R3}) assigned to the coordinate entries corresponding to the highest hierarchy of the scalability L. The above operations generate the three-dimensional key element matrix QM₁₋₃.

The area (b) of FIG. 20 shows the three-dimensional key element matrix QM₂₋₃ generated using the split key e^{RL}_{R2} corresponding to hierarchy 2 (hierarchy higher by one hierarchy than the lowest hierarchy) of the reference scalability R, for hierarchy 0 (highest hierarchy) of the scalability C other than the reference scalabilities L and R.

In generation of this three-dimensional key element matrix QM₂₋₃, the split key e^{RL}_{R2} is assigned to the coordinate entry P_{5,2,0} (the hatched portion in the area (b) of FIG. 20) in the three-dimensional matrix. At this time, the split key e^{RL}_{R2} is copied (CP) once into each of the coordinate entries P_{5,2-3,0-2}. Then, for each of hierarchy 2 (highest hierarchy) to hierarchy 0 (lowest hierarchy) of the scalability C in hierarchy 3 and hierarchy 2 of the scalability R, the hash operation on the split key e^{RL}_{R2} using the one-way hash function H is carried out in order from the lowest hierarchy to the highest hierarchy of the scalability L. Namely, every time the hash operation is carried out, resultant operation data is assigned to a corresponding coordinate entry (all entries located in a region surrounded by solid lines in the area (b) of FIG. 20). At this time, operation data H*⁵(e^{RL}_{R2}) is assigned to each of the coordinate entries corresponding to the highest hierarchy of the scalability L. On the other hand, each of the coordinate entries (all entries located in a region surrounded by dashed lines in the area (b) of FIG. 20) except for the coordinate entries P_{L=0-5,R=2-3,C=0-2} assigned the operation data, is assigned operation data H*⁶(e^{RL}_{R2}) obtained by further carrying out the hash operation with the one-way hash function H on the operation data H*⁵(e^{RL}_{R2}) assigned to the coordinate entries corresponding to the highest hierarchy of the scalability L. The above operations generate the three-dimensional key element matrix QM₂₋₃.

The three-dimensional key element matrix QM₃₋₃ shown in the area (c) of FIG. 20 is also generated in the same manner as in the generation of the three-dimensional key element matrices QM₁₋₃ and QM₂₋₃ described above, by repeating the copy operation of the split key e^{RL}_{R1} (assigned as the coordinate entry P_{5,1,0} indicated by hatching) into each of the lower hierarchies than hierarchy 1 of the reference scalability R and the lower hierarchies than the hierarchy 0 (highest hierarchy) of the scalability C, and the hash operation from the lowest hierarchy to the highest hierarchy of the scalability L (hash operation on the split key e^{RL}_{R1} using the one-way hash function H). Similarly, the three-dimensional key element matrix QM₄₋₃ shown in the area (d) of FIG. 20 is also generated by repeating the copy operation of the split key e^{RL}_{R0} (assigned as the coordinate entry P_{5,0,0} indicated by hatching) into each of the lower hierarchies than the hierarchy 0 (highest hierarchy) of the reference scalability R and the lower hierarchies than the hierarchy 0 (highest hierarchy) of the reference scalability C, and the hash operation from the lowest hierarchy to the highest hierarchy of the scalability L (hash operation on the split key e^{RL}_{R0} using the one-way hash function H).

The three-dimensional partial key matrix QM by the encryption key generating method of the fifth embodiment is obtained by combining the coordinate entries at the same coordinate positions in the three-dimensional key element matrices QM₁₋₁-QM₄₋₁, QM₁₋₂-QM₄₋₂, and QM₁₋₃-QM₄₋₃ shown in FIGS. 18 to 20, which were generated by repetitions of the hash operation described above.

It is obvious that the present invention can be modified in many ways in view of the above description of the present invention. Such modifications should not be construed as a departure from the spirit and scope of the present invention and all improvements obvious to those skilled in the art are intended for inclusion in the scope of claims which follow.

1. An encryption key generating method for generating an encryption key used in coding and decoding of digital data with plural types (≧2) of hierarchical scalabilities, the encryption key generating method comprising the steps of:
preparing as a master key, an encryption key used in coding and decoding of a data unit in hierarchies at a lowest position in each of first and second scalabilities selected from the plural types of scalabilities;
dividing the master key prepared, by a number of hierarchies in the first scalability set as a reference scalability out of the first and second scalabilities, to generate split keys corresponding to the respective hierarchies in the first scalability;
concerning a key element matrix generated based on one split key out of the split keys, assigning operation data successively obtained by repeating a hash operation on the one split key using a one-way hash function, at least to coordinate entries corresponding to respective hierarchies from the lowest hierarchy to the highest hierarchy in the second scalability in a hierarchy in the first scalability corresponding to the one split key, so as to generate key element matrices as coordinate representations of hierarchical values in the first and second scalabilities, for the respective hierarchies in the first scalability; and
combining key elements coordinately consistent among the key element matrices generated, to generate partial keys corresponding to data units in the respective hierarchies in the first and second scalabilities.

2. An encryption key generating method according to claim 1, wherein a scalability with the smaller number of hierarchies out of the first and second scalabilities is selected as the reference scalability.

3. An encryption key generating method according to claim 1, wherein a key element matrix generated based on one split key out of the split keys is generated by assigning the same operation data as operation data successively obtained for a hierarchy of the one split key, to coordinate entries corresponding to respective hierarchies from the lowest hierarchy to the highest hierarchy of the second scalability in a hierarchy at a lower position than the hierarchy in the first scalability corresponding to the one split key, and by assigning operation data obtained by a hash operation with a one-way hash function on a key element in the highest hierarchy of the second scalability out of key elements in the hierarchy corresponding to the one split key, to all coordinate entries corresponding to respective hierarchies from the lowest hierarchy to the highest hierarchy of the second scalability in a hierarchy at a higher position than the hierarchy in the first scalability corresponding to the one split key.

4. An encryption key generating method according to claim 1, comprising the steps of:
for each of all combinations of two types of scalabilities selectable from the plural types of scalabilities, generating a partial key element matrix as a coordinate representation of hierarchical values in the two types of scalabilities;
generating a hierarchy table showing all combinations of hierarchical values in the plural types of scalabilities, the hierarchy table showing a coordinate representation of a partial key matrix whose entries are partial keys corresponding to data units in respective hierarchies in the plural types of scalabilities, by combined hierarchical values; and
for all the combinations of hierarchical values in the hierarchy table, combining entries in the respective partial key element matrices generated for all the combinations of two types of scalabilities, each of which is specified by two hierarchical values out of hierarchical values constituting one combination and types of the scalabilities, to successively generate the partial keys being the entries in the partial key matrix.

5. An encryption key generating method for generating an encryption key used in coding and decoding of digital data with plural types (≧3) of hierarchical scalabilities, the encryption key generating method comprising the steps of:
preparing as a master key, an encryption key used in coding and decoding of a data unit in hierarchies at a lowest position in each of the plural types of scalabilities;
dividing the master key prepared, by a number of hierarchies in a first reference scalability out of first and second reference scalabilities selected from the plural types of scalabilities, to generate split keys corresponding to respective hierarchies in the first reference scalability;
generating a multidimensional key element matrix as a coordinate representation of hierarchical values in the plural types of scalabilities, by a series of operations corresponding to the respective hierarchies in the first reference scalability, for each hierarchy in each of scalabilities other than the first and second reference scalabilities out of the plural types of scalabilities, and, in each of multidimensional key element matrices obtained, assigning at least coordinate entries corresponding to respective hierarchies from the lowest hierarchy to the highest hierarchy in the second reference scalability in a hierarchy in the first reference scalability corresponding to one split key out of the split keys, operation data successively obtained by repeating a hash operation on the one split key using a one-way hash function; and
combining coordinately consistent entries among the multidimensional key element matrices generated by the series of operations corresponding to the respective hierarchies in the first reference scalability, for the respective hierarchies in the other scalability, to generate partial keys corresponding to data units in respective hierarchies in the plural types of scalabilities.

6. An encryption key generating method according to claim 5, wherein each of the multidimensional key element matrices generated by the series of operations corresponding to the respective hierarchies in the first reference scalability, for the respective hierarchies in the other scalability, is generated by assigning coordinate entries corresponding to respective hierarchies from the lowest hierarchy to the highest hierarchy of the second reference scalability in a hierarchy at a lower position than respective corresponding hierarchies of the other scalability and the first reference scalability, the same operation data as operation data successively obtained using one split key assigned to the corresponding hierarchy of the first reference scalability, and by assigning all coordinate entries corresponding to respective hierarchies from the lowest hierarchy to the highest hierarchy of the second reference scalability in a scalability at a higher position than the respective corresponding hierarchies of the other scalability and the first reference scalability, operation data obtained by a hash operation with a one-way hash function on a key element in the highest hierarchy of the second reference scalability out of key elements in the hierarchy corresponding to the one split key.
